(19) United States
(12) Patent Application Publication
(10) Pub. No.: US 2024/0224977 A9
(43) Pub. Date: Jul. 11, 2024

(54) CALIBRATION OF A SPRAYING SYSTEM BY USING SPRAY DETECTIONS

(71) Applicant: Verdant Robotics, Inc., Hayward, CA (US)

(72) Inventors: Patrick Christopher Leger, Belmont, CA (US); Gabriel Thurston Sibley, Alameda, CA (US); Ankur Roy Chowdhury, Union City, CA (US); Dhaivat Kedar Dholakiya, Newark, CA (US)

(21) Appl. No.: 18/491,654

(22) Filed: Oct. 20, 2023

Related U.S. Application Data
(60) Provisional application No. 63/417,986, filed on Oct. 20, 2022.

(51) Int. Cl. A01M 7/00

(52) U.S. Cl. CPC A01M 7/0089; A01M 7/0042

(57) ABSTRACT

Various embodiments of an apparatus, methods, systems and computer program products described herein are directed to an agricultural treatment system and method of operation. The agricultural treatment system may obtain imagery of emitted fluid projectiles at intended target locations. The system may identify positional parameters of a spraying head and/or motors used to maneuver the spraying head to emit the fluid projectile. The system may generate a calibration or lookup table based on a three-dimensional coordinate of the intended target location and of the positional parameters of the spraying head. The system may then use the lookup table to perform subsequent spray operations.

### CROSS-REFERENCE TO RELATED APPLICATIONS

This application is a non-provisional application and claims the benefit of provisional U.S. Patent Application No. 63/417,986, filed Oct. 20, 2022, which is hereby incorporated by reference in their entirety.

### BACKGROUND

To support an increase in demand food production, agricultural technology has been implemented to more effectively and efficiently grow crops, raise livestock, and cultivate land. Such technology in the past has helped to more effectively and efficiently use labor, use tools and machinery, and reduce the amount of chemicals used on plants and cultivated land.

However, many techniques used currently for producing and harvesting crops are only incremental steps from a previous technique. The amount of land, chemicals, time, labor, and other costs to the industry still pose a challenge. A new and improved system and method of performing agricultural services is needed.

### SUMMARY

In one embodiment, the agricultural treatment system uses a treatment unit for spraying fluid at agricultural objects. The treatment unit is configured with a treatment head assembly that includes a moveable treatment head with one or more spraying tips. The agricultural treatment system may include one or more image sensors for obtaining imagery of an environment about the agricultural treatment system. The system may obtain with one or more image sensors at a first time period. The first set of images each include multiple pixels depicting a ground area and a first target agricultural object positioned in the ground area. The system emits a first fluid projectile of a first fluid at the first target agricultural object. The system obtains with the one or more image sensors at a second time period, a second set of images each comprising a plurality of pixels depicting the ground area and the agricultural object. The system compares the first image with the second image to determine a change in pixels between at least a first image of the first set of images and at least a second image of the second set of images. Based on the determined change in pixels as between the first and second images, the system identifies a first group of pixels that represent a first spray object.

In one embodiment, the agricultural treatment system uses a treatment unit uses a treatment unit for spraying fluid at agricultural objects. The treatment unit is configured with a treatment head assembly that includes a moveable treatment head with one or more spraying tips. The agricultural treatment system may include one or more image sensors for obtaining imagery of an environment about the agricultural treatment system. The agricultural treatment system may obtain imagery of emitted fluid projectiles at intended target locations. The system may identify positional parameters of a spraying head and/or motors used to maneuver the spraying head to emit the fluid projectile. The system may generate a calibration or lookup table based on a three-dimensional coordinate of the intended target location and of the positional parameters of the spraying head. The system may then use the lookup table to perform subsequent spray operations.

### BRIEF DESCRIPTION OF THE DRAWINGS

The present disclosure will become better understood from the detailed description and the drawings, wherein:

FIG. 1A is a diagram illustrating an exemplary environment, according to some examples.

FIG. 1B is a diagram illustrating an exemplary environment, according to some examples.

FIG. 2 is a diagram illustrating an example agricultural observation and treatment system, according to some examples.

FIG. 3A is a diagram illustrating an agricultural scene within a geographic boundary, according to some examples.

FIG. 3B is a diagram illustrating image acquisition and digitization of a geographic boundary, according to some examples.

FIG. 4 is a diagram illustrating an example vehicle supporting an observation and treatment system performing in a geographic boundary, according to some examples.

FIG. 5 is a diagram illustrating an additional portion of an example agricultural observation and treatment system, according to some examples.

FIG. 6A is a diagram illustrating an example component of an agricultural observation and treatment system, according to some examples.

FIG. 6B is a diagram illustrating an example component of an agricultural observation and treatment system, according to some examples.

FIG. 7 is a diagram illustrating an example configuration of a system with a treatment unit having an example configuration of a fluid source and fluid flow mechanisms, according to some examples.

FIG. 8 is a diagram illustrating an example image acquisition to object determination performed by an example system, according to some examples.

FIG. 9A is a block diagram illustrating an exemplary method that may be performed by an agricultural observation and treatment system, according to some examples.

FIG. 9B is a block diagram illustrating an exemplary method that may be performed by an agricultural observation and treatment system, according to some examples.

FIG. 10 is a diagram illustrating capturing action and treatment pattern detection, according to some examples.

FIG. 11A is a diagram illustrating an exemplary method that may be performed by an agricultural observation and treatment system, according to some examples.

FIG. 11B is a diagram illustrating an exemplary method that may be performed by an agricultural observation and treatment system, according to some examples.

FIG. 11C is a diagram illustrating an exemplary method that may be performed by an agricultural observation and treatment system, according to some examples.

FIG. 12 is a diagram illustrating an exemplary image of a group pixels of an emitted fluid projectile and a spray impact.

FIG. 13 is a diagram illustrating an exemplary image segmentation and line fitting process.

FIG. 14 is a diagram illustrating an exemplary method of spray object identification and line determination in a 3D space.

FIG. 15 is a diagram illustrating an exemplary method that may be performed by an agricultural observation and treatment system, according to some examples.

FIG. 16 is a diagram illustrating an exemplary method that may be performed by an agricultural observation and treatment system, according to some examples.

FIG. 17 is a diagram illustrating an example of methods described herein, where an agricultural treatment system may perform a calibration process.

FIG. 18 is a diagram illustrating an exemplary method that may be performed by an agricultural observation and treatment system, according to some examples.

FIG. 19 is a diagram illustrating an exemplary method that may be performed by an agricultural observation and treatment system, according to some examples.

FIG. 20 is a diagram illustrating an example using a calibrated agricultural treatment system, according to some examples.

### DETAILED DESCRIPTION

In this specification, reference is made in detail to specific embodiments of the disclosure. Some of the embodiments or their aspects are illustrated in the drawings.

For clarity in explanation, the disclosure has been described with reference to specific embodiments, however it should be understood that the disclosure is not limited to the described embodiments. On the contrary, the disclosure covers alternatives, modifications, and equivalents as may be included within its scope as defined by any patent claims. The following embodiments of the disclosure are set forth without any loss of generality to, and without imposing limitations on, the claimed disclosure. In the following description, specific details are set forth in order to provide a thorough understanding of the present disclosure. The present disclosure may be practiced without some or all of these specific details. In addition, well known features may not have been described in detail to avoid unnecessarily obscuring the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein. Various examples and embodiments described below relate generally to robotics, autonomous driving systems, and autonomous agricultural application systems, such as an autonomous agricultural observation and treatment system, utilizing computer software and systems, computer vision and automation to autonomously identify an agricultural object including any and all unique growth stages of agricultural objects identified, including crops or other plants or portions of a plant, characteristics and objects of a scene or geographic boundary, environment characteristics, or a combination thereof.

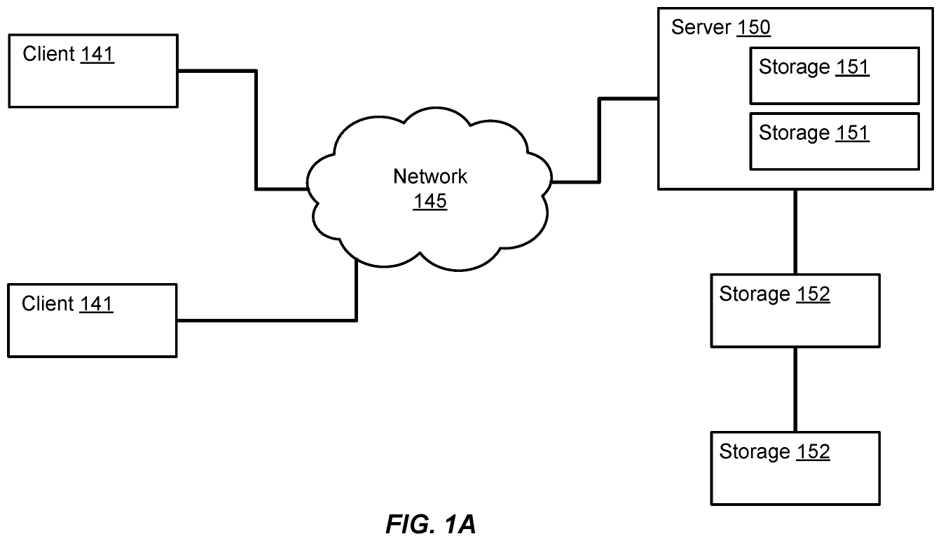

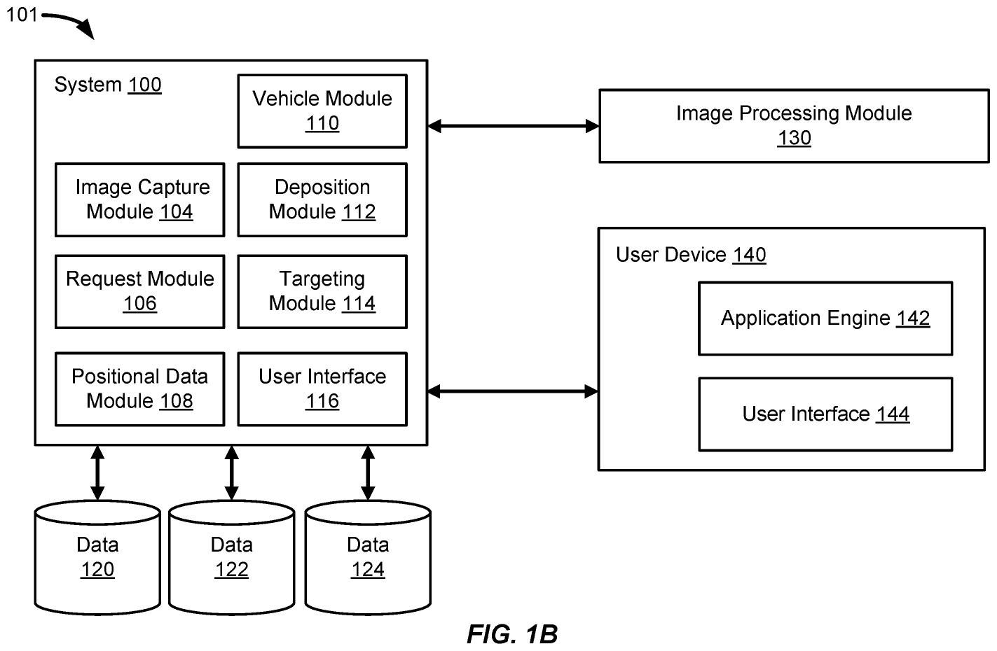

Referring now to FIG. 1A, a diagram of an exemplary network environment in which example systems and devices may operate is shown. In the exemplary environment, clients 141 are connected over a network 145 to a server 150 having local storage 151. Clients and servers in this environment may be computers. Server 150 may be configured to handle requests from clients. Server 150 may be implemented as a number of networked server devices, though it is illustrated as a single entity. Communications and transmissions between a base station and one or vehicles, or other ground mobility units configured to support a server 150, and between a base station and one or more control centers as described herein may be executed similarly as the client 141 requests.

The exemplary environment is illustrated with only two clients and one server for simplicity, though in practice there may be more or fewer clients and servers. The computers have been termed clients and servers, though clients can also play the role of servers and servers can also play the role of clients. In some examples, the client 141 may communicate with each other as well as the servers. Also, the server 150 may communicate with other servers.

The network 145 may be, for example, local area network (LAN), wide area network (WAN), networks utilizing 5G wireless standards technology, telephone networks, wireless networks, intranets, the Internet, or combinations of networks. The server 150 may be connected to storage 152 over a connection medium, which may be a bus, crossbar, network, wireless communication interface, or other interconnect. Storage 152 may be implemented as a network of multiple storage devices, though it is illustrated as a single entity. Storage 152 may be a file system, disk, database, or other storage.

In one example, the client 141 may perform one or more methods herein and, as a result, store a file in the storage 152. This may be accomplished via communication over the network 145 between the client 141 and server 150. For example, the client may communicate a request to the server 150 to store a file with a specified name in the storage 152. The server 150 may respond to the request and store the file with the specified name in the storage 152. The file to be saved may exist on the client 141 or may already exist in the server's local storage 151.

In another embodiment, the client 141 may be a vehicle, or a system or apparatus supported by a vehicle, that sends vehicle sensor data. This may be accomplished via communication over the network 145 between the client 141 and server 150. For example, the client may communicate a request to the server 150 to store a file with a specified file name in the storage 151. The server 150 may respond to the request and store the file with the specified name in the storage 151. The file to be saved may exist on the client 141 or may exist in other storage accessible via the network such as storage 152, or even in storage on the client (e.g., in a peer-to-peer system). In one example, the vehicle can be an electric, gasoline, hydrogen, or hybrid powered vehicle including an all-terrain vehicle, a truck, a tractor, a small rover with bogey rocker system, an aerial vehicle such as a drone or small unmanned aerial system capable of supporting a treatment system including vision components, chemical deposition components, and compute components.

FIG. 1B illustrates a diagram 101 of an example system 100 configured to observe a geographic boundary in the real-world, for example a farm or orchard, perform object detection, classification, identification, of any and all objects in the geographic boundary including agricultural objects, determine any individual agricultural object that may require an agricultural treatment based on the agricultural object's growth stage, previous treatments applied, and other characteristics observed, particularly at the point in time of the observation by system 100, and apply a specific treatment to the agricultural object. The system 100 can include and object observation and treatment engine that includes an image capture module 104, a request module 106, a positional data module 108 for capturing, fusing, and transmitting sensor data related to position, localization, pose, velocity, and other position related signals to the rest of the system 100, a vehicle module 110, a deposition module 112 for applying a liquid or light treatment on each individual object detected and determined to require a treatment, a targeting module 114 for targeting and tracking an identified object in the real-world based on sensor data and object detection in an image captured of the real-world while a vehicle is moving, and a user interface (U.I.) module 116. The system 100 may communicate with a user device 140 to display output, via a user interface 144 generated by an application engine 142. In one example, the deposition module 112 can also be a treatment module configured to perform non fluid type deposition treatment including having a mechanical mechanism or end effector, including mechanical arms, blades, injectors, drills, tilling mechanism, etc., that physically interacts with surfaces or roots of plant objects or soil.

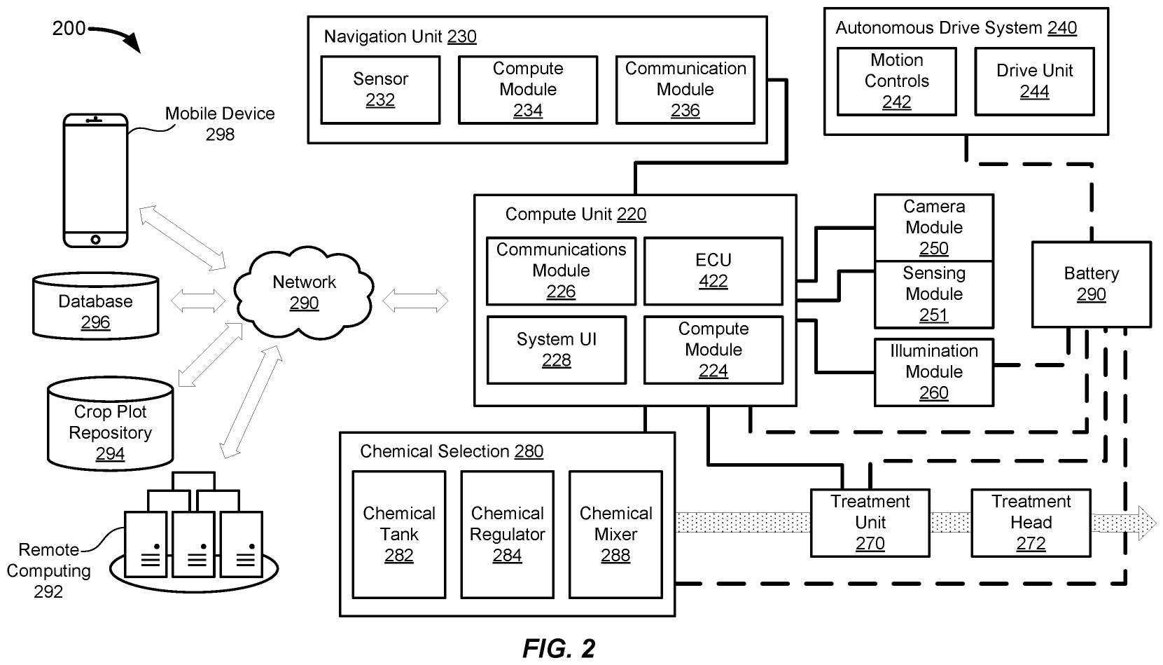

FIG. 2 illustrates a system architecture of an agricultural observation and treatment system, or agricultural treatment system 200, or treatment system. The agricultural treatment system 200 can include a robot having a plurality of computing, control, sensing, navigation, process, power, and network modules, configured to observe a plant, soil, agricultural environment, treat a plant, soil, agricultural environment, or a combination thereof, such as treating a plant for growth, fertilizing, pollenating, protecting and treating its health, thinning, harvesting, or treating a plant for the removal of unwanted plants or organisms, or stopping growth on certain identified plants or portions of a plant, or a combination thereof.

In this example, the agricultural treatment system 200 agricultural treatment system 400 can include an on-board computing unit 220, such compute unit 220 computing unit embedded with a system on chip. The on-board computing unit can include a compute module 224 configured to process images, send and receive instructions from and to various components on-board a vehicle supporting the agricultural treatment system 200 agricultural treatment system 200. The computing unit can also include an engine control unit 222, a system user interface, system UI 228, and a communications module 226.

The ECU 222 can be configured to control, manage, and regulate various electrical components related to sensing and environment that the agricultural treatment system 200 will maneuver in, electrical components related to orienting the physical components of the agricultural treatment system 200, moving the agricultural treatment system 200, and other signals related to managing power and the activation of electrical components in the treatment system. The ECU 222 can also be configured to synchronize the activation and deactivation of certain components of the agricultural treatment system 200 such as activating and deactivating the illumination module 260, and synchronize the illumination module 260 with one or more cameras of the camera module 250 or one or more other sensors of the sensing module 251 for sensing an agricultural scene for observation and treatment of agricultural objects.

The compute module 224 can include computing devices and components configured to receive and process image data from image sensors or other components. In this example, the compute module 224 can process images, compare images, identify, locate, and classify features in the images including classification of objects such as agricultural objects, landmarks, or scenes, as well as identify location, pose estimation, or both, of an object in the real world based on the calculations and determinations generated by compute module 224 on the images and other sensor data fused with the image data. The communications module 226, as well as any telemetry modules on the computing unit, can be configured to receive and transmit data, including sensing signals, rendered images, indexed images, classifications of objects within images, data related to navigation and location, videos, agricultural data including crop yield estimation, crop health, cluster count, amount of pollination required, crop status, size, color, density, etc., and processed either on a computer or computing device on-board the vehicle, such as one or more computing devices or components for the compute module 224, or remotely from a remote device close to the device on-board the vehicle or at a distance farther away from the agricultural scene or environment that the agricultural treatment system 200 maneuvers on.

For example, the communications module 226 can communicate signals, through a network 290 such as a wired network, wireless network, Bluetooth network, wireless network under 5G wireless standards technology, radio, cellular, etc. to edge and cloud computing devices including a mobile device 540, a device for remote computing of data including remote computing 292, databases storing image and other sensor data of crops such as crop plot repository 294, or other databases storing information related to agricultural objects, scenes, environments, images and videos related to agricultural objects and terrain, training data for machine learning algorithms, raw data captured by image capture devices or other sensing devices, processed data such as a repository of indexed images of agricultural objects. In this example, the mobile device 540 can control the agricultural treatment system 200 through the communications module 226 as well as receive sensing signals from a telemetry module. The mobile device 298 can also process images and store the processed images in the databases 296 or crop plot repository 294, or back onto the on-board computing system of agricultural treatment system 200. In one example, remote computing 530 component can be one or more computing devices dedicated to process images and sensing signals and storing them, transferring the processed information to the database 296, or back to the on-board computing device of agricultural treatment system 200 through the network 290.

In one example, the agricultural treatment system 200 includes a navigation unit 230 with sensors 432. The navigation unit 230 can be configured to identify a pose and location of the agricultural treatment system 200, including determining the planned direction and speed of motion of the agricultural treatment system 200 in real time. The navigation unit 230 can receive sensing signals from the sensors 232. In this example, the sensing signals can include images received from cameras or Lidar's. The images received can be used to generate a grid map in 2D or 3D based on simultaneous visualization and mapping (SLAM) including geometric SLAM and Spatial SLAM techniques, visual odometry, or both, of the terrain, ground scene, agricultural environment such as a farm, etc. The sensing signals from the sensors 232 can also include depth signals from depth sensing cameras including RGB-D cameras or infrared cameras, or calculated with stereo vision mounted sensors such as stereo vision cameras, as well as other signals from radar, radio, sonar signals, photoelectric and photooptic signals, as well as location sensing signals, from having a global positioning system (GPS) unit, encoders for wheel odometry, IMU's, speedometers, etc. A compute module 234, having computing components such as a system on chip or other computing device, of the navigation unit 230, or compute module 224 of the compute unit 220, or both, can fuse the sensing signals received by the sensors 232, and determine a plan of motion, such as to speed up, slow down, move laterally, turn, change the rocker orientation and suspension, move, stop, or a combination thereof, or other location, pose, and orientation-based calculations and applications to align a treatment unit 270 with the ground, particularly with an object of interest such as a target plant on the ground. In one example, the navigation unit 230 can also receive the sensing signals and navigate agricultural treatment system 200 autonomously. For example, an autonomous drive system 240 can include motion components including a drive unit 244 having motors, steering components, and other components for driving a vehicle, as well as motion controls 242 for receiving instructions from the compute module 224 or compute module 224, or both, to control the drive unit and move the vehicle, autonomously, from one location and orientation to a desired location and orientation.

In one example, the navigation unit 230 can include a communications module 236 to send and receive signals from other components of the agricultural treatment system 200 such as with the compute unit 220 or to send and receive signals from other computing devices and databases off the vehicle including remote computing devices over the network 290.

In another example, the navigation unit 230 can receive sensing signals from a plurality of sensors including one or more cameras, Lidar, GPS, Thais, VO cameras, SLAM sensing devices such as cameras and LiDAR, lasers, rangefinders, sonar, etc., and other sensors for detecting and identifying a scene, localizing the agricultural treatment system 200 and treatment unit 270 onto the scene, and calculating and determining a distance between the treatment unit 270 and a real world agricultural object based on the signals received, fused, and processed by the navigation unit 230, or sent by the navigation unit 230 to be processed by the compute module 224, and/or another on-board computing device of the treatment system 200. The images received can be used to generate a map in 2D or 3D based on SLAM, visual odometry including geometry based or learning based visual odometry, or both, of the terrain, ground scene, agricultural environment such as a farm, etc. The sensing signals can also include depth signals, from having depth sensing cameras including RGB-D cameras or infrared cameras, a radar, radio, sonar signals, photoelectric and photooptic signals, as well as location sensing signals from GPS, encoders for wheel odometry, Thais, speedometers, and other sensors for determining localization, mapping, and position of the agricultural treatment system 200 to objects of interest in the local environment as well as to the regional agricultural environment such as a farm or other cultivated land that has a designated boundary, world environment, or a combination thereof. The navigation unit 230 can fuse the sensing signals received by the sensors, and determine a plan of motion, such as to speed up, slow down, move laterally, turn, move, stop, change roll, pitch, and/or yaw orientation, or a combination thereof, or other location, localization, pose, and orientation-based calculations and applications.

In one example, the navigation unit 230 can include a topography module configured to utilize sensors, computer components, and circuitry configured to detect uneven surfaces on a plane or scene of the terrain which allows the topography module to communicate with the rest of the components of the treatment system to anticipate, adjust, avoid, compensate for, and other means of allowing the agricultural treatment system 200 to be aware of uneven surfaces detected on the terrain as well as identify and map unique uneven surfaces on the terrain to localize the vehicle supporting the navigation unit 230.

In one example, the agricultural treatment system 200 includes a camera module 450 having one or more cameras, sensing module 251 having other sensing devices, or both, for receiving image data or other sensing data of a ground, terrain, orchard, crops, trees, plants, or a combination thereof, for identifying agricultural objects, such as flowers, fruits, fruitlets, buds, branches, plant petals and leaves, plant pistils and stigma, plant roots, or other subcomponent of a plant, and the location, position, and pose of the agricultural objects relative to a treatment unit 270, camera module 250, or both, and its position on the ground or terrain. The cameras can be oriented to have a stereo vision such as a pair of color or black and white cameras oriented to point to the ground. Other sensors of sensing module 251 can be pointed to the ground or trees of an orchard for identifying, analyzing, and localizing agricultural objects on the terrain or farm in parallel with the cameras of the camera module 250 and can include depth sensing cameras, LiDAR's, radar, electrooptical sensors, lasers, etc.

In one example, the agricultural treatment system 200 can include a treatment unit 270 with a treatment head 272. In this example, the treatment unit 270 can be configured to receive instructions to point and shine a laser, through the treatment head 272, to treat a target position and location on the ground terrain relative to the treatment unit 270.

The agricultural treatment system 200 can also include motion controls 242, including one or more computing devices, components, circuitry, and controllers configured to control mechatronics and electronic components of a vehicle supporting the agricultural treatment system 200 configured to move and maneuver the agricultural treatment system 200 through a terrain or orchard having crops and other plants of interest such that, as the agricultural treatment system 200 maneuvers through the terrain, the cameras 250 are scanning through the terrain and capturing images and the treatment unit is treating unwanted plants identified in the images captured from the camera module 250 and other sensors from sensing module 251. In one example, an unwanted plant can be a weed that is undesirable for growing next or near a desirable plant such as a target crop or crop of interest. In one example, an unwanted plant can be a crop that is intentionally targeted for removal or blocking growth so that each crop growing on a specific plant or tree can be controlled and nutrients pulled from the plant can be distributed to the remaining crops in a controlled manner.

The agricultural treatment system 200 can also include one or more batteries 290 and one or configured to power the electronic components of the agricultural treatment system 200, including DC-to-DC converters to apply desired power from the battery 290 to each electronic component powered directly by the battery.

In one example, the illumination module 260 can include one or more light arrays of lights, such as LED lights. The one or more light arrays can be positioned near the one or more cameras or sensors of camera module 250 and sensor module 251 to provide artificial illumination for capturing bright images. The light arrays can be positioned to point radially, from a side of the vehicle, pointed parallel to the ground, and illuminate trees or other plants that grow upwards. The light arrays can also be positioned to be pointed down at the ground to illuminate plants on the ground such as row crops, or other plants or soil itself. The light arrays can be controlled by the ECU 222, as well as by a synchronization module, embedded in the ECU 222 or a separate electronic component or module, such that the lights only flashes to peak power and luminosity for the length of 1 frame of the camera of camera module 250, with a matched shutter speed. In one example, the lights can be configured by the ECU 222 to flash to peak power for the time length of a multiple of the shutter speed of the camera. In one example, the lights of the light array can be synchronized to the cameras with a time offset such that the instructions to activate the LED's of the light array and the instructions to turn on the camera and capture images are offset by a set time, predetermined time, or automatically calculated time based on errors and offsets detected by the compute unit 220, so that when the LED's actually activate to peak power or desired luminosity, which will be a moment in time after the moment in time the ECU sends a signal to activate the light array, the camera will also activate at the same time and capture its first image, and then both the lights and cameras will be synchronized and run at the same frequency. In one example, the length of time of the peak power of the activated light is matched and synchronized with the exposure time of each frame captured of the camera, or a multiple of the exposure time. In one example, the cameras can include

In one example, the agricultural treatment system 200 can include a treatment unit 270 with a treatment head 272. In this example, the treatment unit 270 can include a turret and circuitry, electronic components and computing devices, such as one or more microcontrollers, electronic control units, FPGA, ASIC, system on chip, or other computing devices, configured to receive instructions to point and a treatment head 272, to treat a surface of a real-world object in proximity of the treatment unit 270. For example, the treatment unit 270 can emit a fluid projectile of a treatment chemical onto an agricultural object in the real world based on detecting the agricultural object in an image captured and determining its location in the real world relative to the treatment unit 270.

The treatment unit 270 can include a gimbal assembly, such that the treatment head 272 can be embedded in, or supported by the gimbal assembly, effectively allowing the treatment head 272 to rotate itself and orient itself about one or more rotational axes. For example, the gimbal assembly can have a first gimbal axis, and a second gimbal axis, the first gimbal axis allowing the gimbal to rotate about a yaw axis, and the second gimbal axis allowing the gimbal to rotate about a pitch axis. In this example, a control module of the treatment unit can control the gimbal assembly which changes the rotation of the gimbal assembly about its first gimbal axis, second gimbal axis, or both. The compute module 224 can determine a location on the ground scene, terrain, or tree in an orchard, or other agricultural environment, and instruct the control module of the treatment unit 270 to rotate and orient the gimbal assembly of the treatment unit 270. In one example, the compute module 224 can determine a position and orientation for the gimbal assembly to position and orient the treatment head 272 in real time and make adjustments in the position and orientation of the treatment head 272 as the agricultural treatment system 200 is moving relative to any target plants or agricultural objects of interest on the ground either in a fixed position on the ground, or is also moving. The agricultural treatment system 200 can lock the treatment unit 270, at the treatment head 272, onto the target plant, or other agricultural object of interest through instructions received and controls performed by the control module of the treatment unit 270, to adjust the gimbal assembly to move, or keep and adjust, in real time, the line of sight of the treatment head 272 onto the target plant.

In one example, a chemical selection module, or chemical selection 280, of agricultural treatment system 200 agricultural treatment system 200 can be coupled to the compute module 224 and the treatment unit 270. The chemical selection module can be configured to receive instructions to send a chemical fluid or gas to the treatment unit 270 for treating a target plant or other object. In this example, the chemical selection module can include one or more chemical tanks 282, one or more chemical regulators 284 operable connected to the one or more chemical tanks 284 such that there is one chemical regulator for tank, a pump for each tank, and a chemical mixer 288 which can mix, in real time, chemical mixtures received from each chemical tank selected by the chemical mixer 288. In one example, a vehicle supporting the agricultural treatment system 200 agricultural treatment system 200, including the chemical selection module 280, can support one chemical tank 282, a chemical pump, a chemical regulator 286, a chemical and a chemical accumulator, in series, linking connecting a pathway for a desired chemical or liquid to travel from a stored state in a tank to the treatment unit 270 for deposition on a surface of an object. The chemical regulator 484 can be used to regulate flow and pressure of the fluid as it travels from the pump to the treatment unit. The regulator 484 can be manually set by a user and physically configure the regulator on the vehicle, or controlled by the compute unit 220 at the compute module 224 or ECU 422. The chemical regulator 284 can also automatically adjust flow and pressure of the fluid from the pump to the treatment unit 270 depending on the treatment parameters set, calculated, desired, or a combination thereof. In one example, the pump can be set to move fluid from the storage tank to the next module, component, in the series of components from the chemical tank 282 to the treatment unit 270. The pump can be set at a constant pressure that is always pressurized when the vehicle and agricultural treatment system 200 agricultural treatment system 200 is currently running a trial for plant or soil treatment. The pressure can then be regulated to controlled from the constant pressure at the regulator, and also an accumulator 287, so that a computer does not need to change the pump pressure in real time. Utilizing a regulator and accumulator can cause the pressure needed for the spray or emission of a fluid projectile to be precisely controlled, rather than controlling voltage or power of the pump. In one example, the agricultural treatment system 200 agricultural treatment system 200 will identify a target plant to spray in the real world based on image analysis of the target plant identified in an image captured in real time. The compute unit 220 can calculate a direction, orientation, and pressurization of the treatment unit 270 such that when the treatment unit 270 activates and opens a valve for the pressurized liquid to pass from the chemical selection module 280 to the treatment unit 270, a fluid projectile of a desired direction, orientation, and magnitude, from the pressure, will be emitted from the treatment unit 270 at the treatment head 272. The pump will keep the liquid stream from the chemical tank 282 to the treatment unit 270 at a constant pressure, whether or not there is flow. The chemical regulator 284 in the series of components will adjust and step down the pressure to a desired pressure controlled manually before a trial, controlled by the compute unit 220 before the trial, or controlled and changed in real time during a trial by the compute unit 220 either from remote commands from a user or automatically calculated by the compute module 224. The accumulator 287 will keep the liquid stream in series pressurized to the desired pressure adjusted and controlled by the chemical regulator 284, even after the treatment unit 270 releases and emits pressurized fluid so that the stream of fluid from the pump to the treatment unit 270 is always kept at a desired pressure without pressure drops from the release of pressurized fluid.

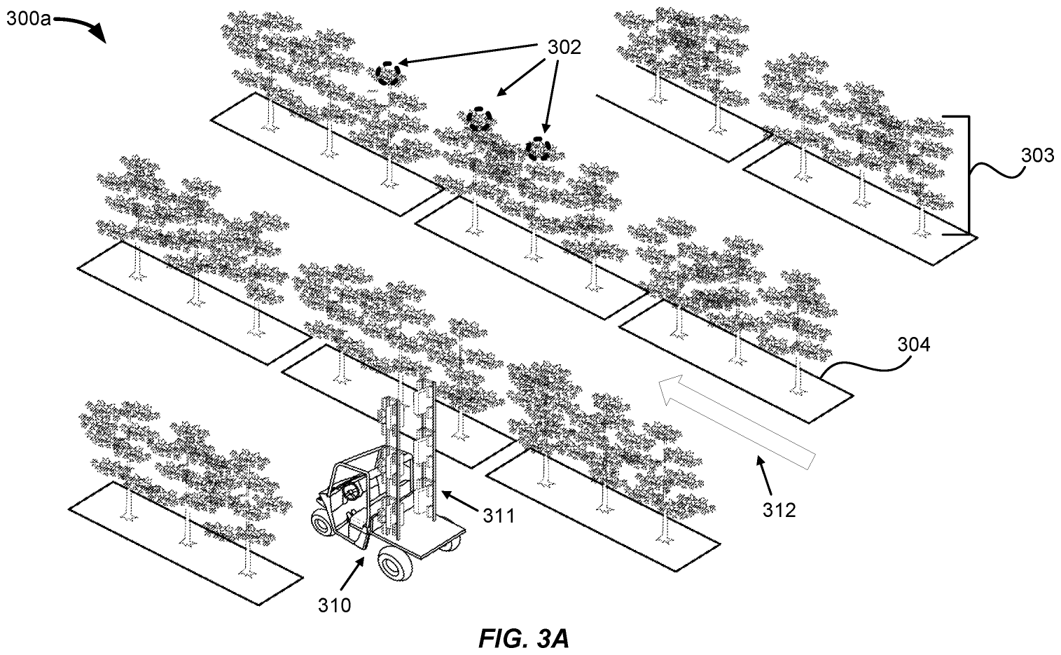

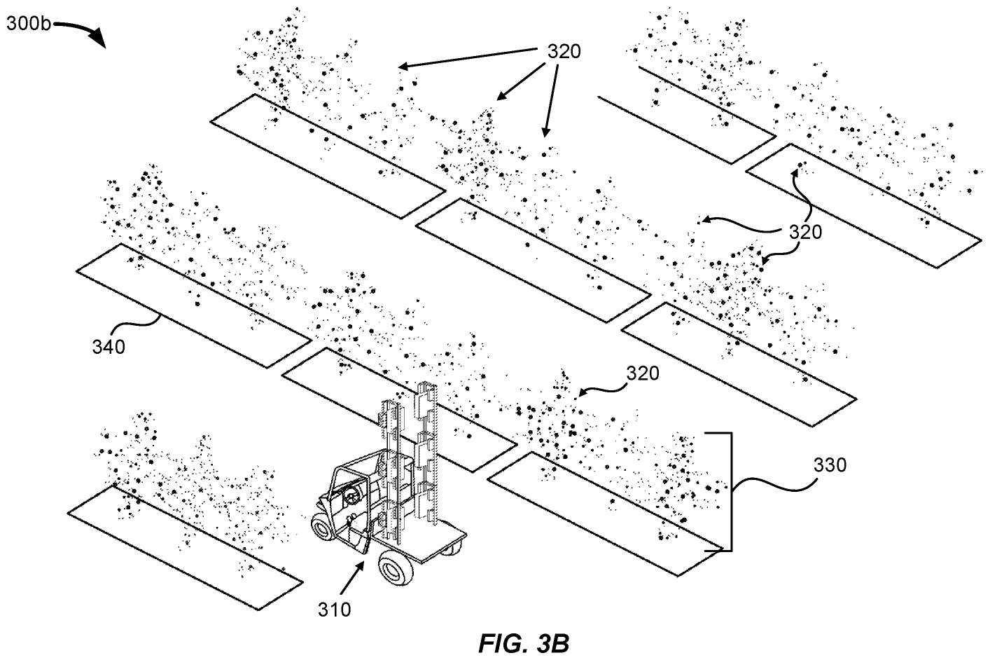

FIG. 3A illustrates a diagram 300a depicting an agricultural scene. The agricultural scene can be any physical environment in the real-world used for agriculture such as, but not limited to, a farm or orchard. The agricultural scene can be contained in a regional geographic boundary or a region without any defined boundaries. The agricultural scene can include agricultural objects including a plurality of one or more different types of plants objects having different plant phenology depending on the season or year on the same agricultural scene. The agricultural objects can be further observed and categorized based on each plant anatomy. For example, diagram 300a can illustrate an orchard having permanent plants, such one or more trees 303. These trees 303 can be permanent trees that can produce crop such as fruit trees or nut trees in seasonal or yearly cycles for multiple years. The plants can also be row crops for harvesting where the plants themselves are for harvest. The agricultural objects observed and potentially treated can be further categorized and identified by the anatomy of the specific type of tree 303. For example, a plant such as a tree 303 can include a trunk, root, branch, stems, leaves, pedals, flowers, plant pistils and stigma, buds, fruitlets, fruits, and many other portions of a plant that make up the plant's anatomy, all of which can be agricultural objects of interest for observation and treatment. For example, the tree 303 in diagram 300a can include one or more agricultural objects 302. These objects can include fruiting flowers or fruitlets that an agricultural treatment system can detect and identify in real-time, and perform an action to treat the flower or fruitlet.

The agricultural scene can also include an agricultural observation and treatment system 311, supported by an example vehicle 310, performing observations and actions in the agricultural scene. In one example, the vehicle 310 can travel inside an orchard along a path 312 such that the agricultural observation and treatment system 311 can sense, identify, perform actions on specific agricultural objects 302 in real time, and index and store the sensed objects 302 and action history, such that the observation and treatment system 311 can use the previously stored information about the specific object 302 that was observed and treated for its next treatment upon detection at a later time or a later phenological stage of the specific object 302. The agricultural observation and treatment system 311 itself can be a component or subsystem of a larger system that can perform computations, store and display information, make decisions, and transmit and receive data from a plurality of agricultural observation and treatment systems performing observations and actions on a plurality of geographic scenes.

In one example, the agricultural scene can be that of an orchard having a plurality of fruiting trees planted in rows as illustrated in diagram 300a. The rows can be further partitioned and categorized by zones 304. In this example, the treatment system 311 can perform a different variety of chemical treatments with varying treatment parameters, such as chemicals used, chemical composition, treatment frequency, and perform A/B type testing (A/B testing) on the agricultural scene by different zones of the same plant type, different chemical trials in the same or different zones or by different individual plant object for harvest, or a combination thereof. The A/B testing for best treatment or best trial discovery can performed at a microarray level such that varying chemical types can be used in real time and varying chemical compositions and concentrations can be used in real time. These combinations can go up to over a million different combinations of different compositions, concentrations, volume, frequency of chemical treatment on varying plant varieties at different stages of growth. In one example, the agricultural observation and treatment system 311 can apply and log each of these different possibilities of varying treatment parameters and perform A/B testing on each zone, each tree, or each crop level specificity to determine the optimal treatment process for each plant or crop type that has not been previously identified in the industry. For example, as the agricultural observation and treatment system 311 applies different treatment parameters to different objects in the same geographic region throughout the growing cycle, upon harvest, some fruiting objects will have more desirable traits and characteristics as that of others, of the same type of crop. The agricultural observation and treatment system 311 can determine which exact object treated and logged from the beginning of the grow cycle for that particular object of the crop, determine the objects specific treatment history, including treatments used, concentration, volume, frequency, etc. and determine that the particular treatment process based on the treatment history of that particular object, that fruited into the most desired version of the crop, is the optimal process based on the A/B testing.

Additionally, based on the zone 304 of plants that produces the best crops, or the best crop at the individual object or fruit level of each zone 304, the best crops being based on size, health, color, amount, taste, etc. crop, the agricultural observation and treatment system 311 can determine the best method of performing treatment actions, based on a variety of parameters that can be adjusted and customized, and apply the same method of treatment actions on the particular zone 304 that yielded the best crop, for other crops in a new or subsequent crop cycle. In one example, treating each agricultural objects with a different treatment parameter to determine the best method of treating a crop does not have to be partitioned by zones 304. The agricultural observation and treatment system 311 can identify, tag, observe, log each unique agricultural object 302 and treat each agricultural object 302 of interest at the individual agricultural object level. For example, instead of treating a first zone 304 with a certain amount or type of chemical of each agricultural object and treating a second zone 304 with a different amount or type of chemical, the treatment system 311 can treat a first agricultural object 302, such as plant bud, and a second agricultural object 302, a different plant bud at the same stage of growth as that of the first plant bud, to observe and discover which bud yields the better fruit.

In one example, the agricultural scene is an orchard having a plurality of rows and trees planted in each row. The vehicle 310 can autonomously travel through each row such that the treatment system 311 can scan one or more trees 303 along a path of the vehicle to detect various agricultural objects including agricultural objects 302 for treatment. Once the treatment system 311's sensing system senses a potential agricultural object, the system 311 can determine whether the agricultural object 302 detected is a new object identified for the first time, a previously identified, tagged, and stored object detected again, a previously identified, tagged, and stored object detected again, that has changed its state or stage of growth in its phenological cycle, a previously identified object that has moved or changed in anatomy, or other objects with varying characteristics detected such as stage of growth, size, color, health, density, etc. Once the object is detected in real time, whether it is of an object previously identified and mapped onto a virtual agricultural scene representing the real agricultural scene, the treatment system 311 can determine, based on a combination of determining the agricultural object's identity, phenotype, stage of growth, and treatment history, if any, whether to perform a unique action onto the agricultural object 302 identified. The action can be that of a chemical fluid projectile emitted from a device as part of the treatment 311 directly onto a portion of a surface of the agricultural object 302. The fluid can be a single liquid projectile similar to that of a shape of a water droplet emitted from a water sprayer, a mist or aerosol, a volumetric spray across a period of time, or many other types of fluid that can be emitted from a device discussed later in this disclosure.

The actions performed by the observation and treatment system 311 can be performed for the purposes similar to that of many actions typically performed in agriculture. These actions can include soil and fertilizer deposition, emitting seeds from the treatment system 311 into soil or dirt, treating individual plant objects including thinning, weeding, pollinating, pruning, extracting, harvesting, among many other actions that can be performed by a treatment system 311 having a device configured to sense an individual object and its stage of growth, access its treatment history, and perform a physical action including emitting a fluid, small object, or shine a light source such as a laser onto the individual object, physically manipulate the object including removing or moving the object for better sense and treatment of another object, destroying the object, pruning or harvesting the object, or a combination thereof.

In one example, the agricultural scene and geographic region can be a farm where the ground or terrain is partitioned into a plurality of rows with row crops for planting, growing, and harvesting and the plants themselves are harvested, unlike that of orchards where agricultural objects are harvested from permanent plants. The observation and treatment can be observed and performed on the crops themselves, or of other plants of interest. For example, weeds can grow in the same agricultural scene as that of a crop of interest such that the observation and treatment performed by treatment system 311 can be that of both the crop and the one or more different types of weeds, or just the weeds. In another example, the agricultural scene can be that of a farm, orchard, or any kind of ground terrain that does not yet have any trees or crops, but only of dirt and soil.

FIG. 3B illustrates diagrams 300b depicting a portion of a virtual and digitized agricultural scene or area similar to that of agricultural scene in diagram 300a. The treatment system 311, having perception and navigation related sensors and a plurality of modular treatment modules each having its own sensors, including vision and navigation sensors, compute units, treatment devices or units, illumination devices, can be supported by a vehicle 310 that can drive along a path, and can be configured to scan and observe a geographic scene and build a virtual map of the scene.

In general, the vehicle 310 moves along a path in the real world while the agricultural observation and agricultural treatment system 311 obtains imagery and other sensed readings, including images captured by image capture devices or point clouds captured by LiDAR's, or a plurality of different sensor readings captured by a plurality of different sensors, of the external environment. The observation and treatment system can generate points along the path representing external agricultural objects (e.g., plants, crops, trees, debris, patterns, landmarks, keypoints or salient points, patterns, cluster of features or patterns that are fixed in space, etc.).

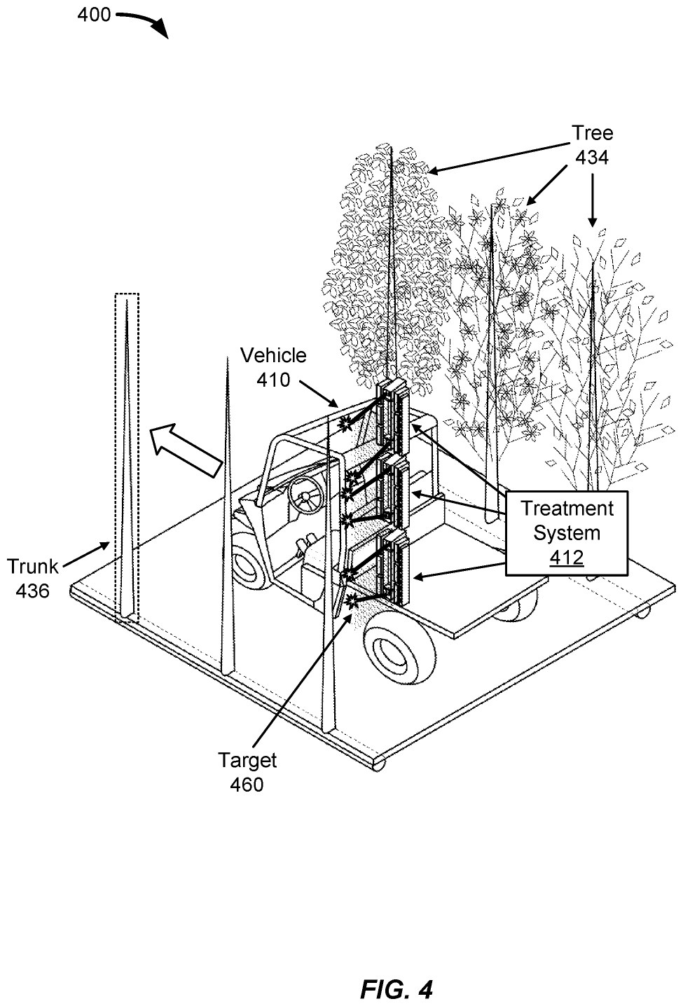

FIG. 4 is a diagram 400 illustrating an example vehicle 410 supporting an example observation and treatment system, or treatment system 412, performing in a geographic boundary, according to some examples. In this example, the vehicle 410 can support one or more modular treatment systems 412. The treatment systems 412 can be similar to that of agricultural observation and treatment systems described above. For example, a system can include onboard and offline components performing tasks both in real time while a vehicle supporting the onboard portions of components are performing observations and actions and at edge compute device or remotely both in real time or offline.

For example, the treatment system 412 can be one of a plurality of modular component treatment systems, each component treatment system can include one or more sensors including image capture sensors, illumination devices, one or more treatment units, for example a pair of treatment units each with a treatment head capable of aiming at a target 460 with at least 2 degrees of rotational freedom, a compute unit configured to send and receive instructions of sensors, encoders, and actuators and connected and associated with the component treatment system and the compute unit to time sync all of the components, and other electronics to sync and communicate with other compute units of other component treatment systems. Each of these treatment systems 412 can receive treatment fluids from a common pressurized source of fluid, or each treatment unit is connected to different sources of fluid. The component treatment systems are configured to sense targets 460 in real time while supported by the moving vehicle 412, determine what kind of treatment, or other action, to perform on to a surface of the target 460, target and track the target 460, predict performance metrics of the instructed parameters of the action including projectile location, perform the action, including emitting a fluid projectile or light source, and evaluating the efficacy and accuracy of the action.

In one example, a geographic boundary can be configured to have two rows of plants on each side of a single lane for a vehicle to navigate through. On each side of the vehicle will be vertically growing plants such as trees. The treatment system 412 can be mounted on the vehicle in a way that image sensors of the treatment system 412 are pointing directly at the trees on each two left and right side of the vehicle. As the vehicle operates along a lane or path in the orchard, the treatment system 412 can capture a series of images from one side to another of the row of plants as well as treat each agricultural object with a precision treatment.

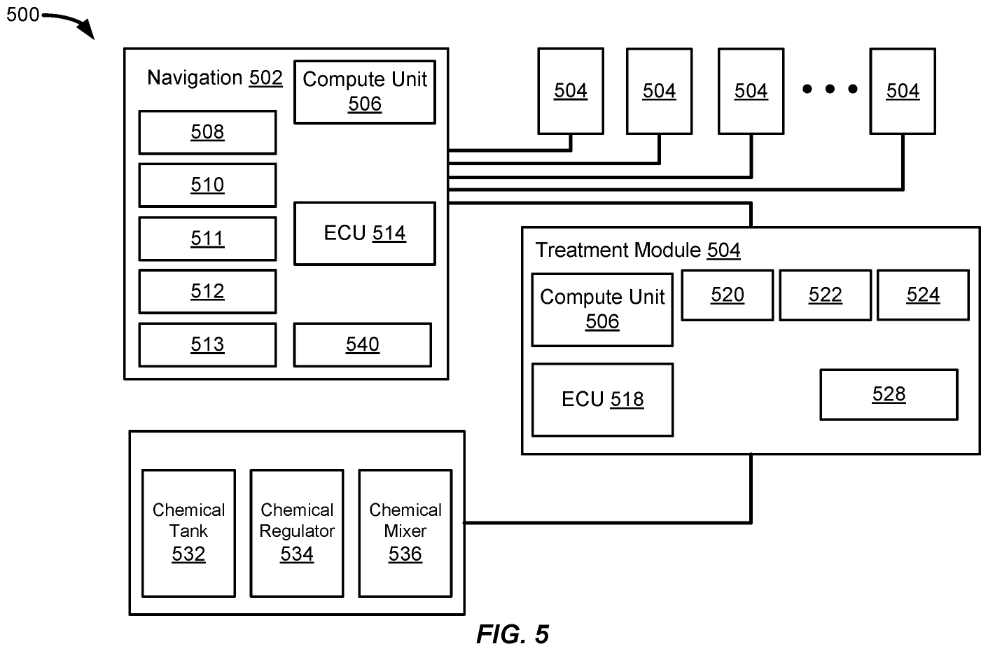

FIG. 5 illustrates an example schematic block diagram of componentry that may be utilized with a system 500 similar to that of agricultural observation and treatment systems described previously in this disclosure. The system 500 may include a sub-system 502 that communicates with one or more perches, or treatment modules 504. The treatment module 504 can be a component of a modular system of one or more treatment devices. In each treatment module 504, the treatment module 804 can include, one or more image sensors 520 and 522, and one or more illumination units 524. In one example, an agricultural observation and treatment system, described in this disclosure, can be referred to as a portion of a system for observing and treating objects that is onboard a moving vehicle. Performances by the portion of the system onboard the moving vehicle, including computations, and physical actions, can be considered online performance or live performance.

The treatment module 504 can include a compute unit 506, which can include a CPU or system on chip, that sends data and instructions to an ECU 518, or daughterboard ECU, for synchronization of operation of one or more illumination units 524 and operation of image sensors 520 and 522. The ECU 518 can sends/receives data to one or more cameras of image sensors 520, and/or one or more cameras of image sensors 522, and one or more illumination units 524 each including a light bar of LEDs, including instructions by the ECU 528 to activate the image sensors 520 and 522 and illumination units 524.

The system 500 can also include a navigation unit 502 configured to interface with each treatment module 504. The navigation unit 502 can include one or more components and modules configured to receive positional, velocity, acceleration, GPS, pose, orientation, and localization and mapping data. In one example, the navigation unit 502 can include a vehicle odometry module 508 with encoders and image sensors to perform wheel odometry or visual odometry and process images and vehicle movement to calculate and determine a position and orientation of the vehicle supporting the system 500. The navigation unit can also include an IMU module 510 with one or more IMU sensors, including accelerometers, gyroscopes, magnetometers, compasses, and MEM and NEM sensors to determine IMU data. The navigation unit 502 can also include an GPS module 511 to receive GPS location data, for example up to a centimeter accuracy. The navigation unit can also include a SLAM module 512 for performing a simultaneous localization and mapping algorithm and application for mapping an environment including an agricultural geographic boundary such as a farm, orchard, or greenhouse, and determining localization and orientation of a vehicle supporting the system 500, components of the system 500 relative to the geographic boundary, as well as localization and orientation of agricultural objects and scenes detected by the system 500. The SLAM module 512 can take sensor data from one or more cameras, including stereo vision cameras, cameras that are omnidirectional, cameras that are moving relative to the vehicle, or other sensors 513 including LiDAR sensors. The LiDAR sensors can be flash LiDAR sensors or static LiDAR sensors, spinning LiDAR sensors, other rangefinders, and other sensors discussed above. As the navigation 802 receives sensing data related to localization and mapping, a compute unit 506, including a CPU or system on chip, of the navigation unit 502 can fuse the sensing signals and send the data to each of the treatment modules 504 or to a remote compute unit or server through a communications module 540. The sensing components of the navigation unit 502 can be activated and controlled by an ECU 514. The ECU 514 can also be configured to interface, including activation and power regulation, with each of the treatment modules 504.

The treatment module 504 can also include a treatment unit 528 configured to receive instructions from the compute unit and ecu 518 including treatment parameters and treatment trajectory of any fluid projectile that is to be emitted from the treatment unit 528. A chemical selection unit 526 can include one or more chemical pump(s) configured to receive non-pressurized liquid from one or more chemical tanks 532 and operable to each treatment units of each of the treatment modules 504, or multiple treatment units 528 of each treatment module 504. One or more chemical tanks 532 may have different types of chemicals. The chemical pumps can send stored liquid or gas from the one or more chemical tank(s) 532 to one or more regulators 534, which will further send pressurized liquid to one or more other components in series as the pressurized liquid reaches the one or more treatment units 528 of system 500. Other components in the series of the chemical selection unit 526 can include an accumulator and chemical mixer 536 (described in previous sections of the disclosure). The treatment unit may emit the liquid at a particular trajectory in order for the fluid projectile to come into contact with an object and at a particular physical location.

In one example, as a vehicle performs a trial on a geographic boundary, each of the treatment modules 504 can perform actions independently of each other. Each treatment module 504 can receive its own image acquisition and processing of images for treatment. The treatment parameters can be determined locally on each treatment module 504, including object detection and classification of agricultural objects in a scene as well as determining treatment parameters based on the objects and features detected. The processing and be performed by each compute unit 506 of each treatment module 504. Each of the treatment modules 504 can receive the same data sensed, fused, and processed by navigation, vehicle orientation and position data from the navigation unit 502 since each of the treatment modules 504 will be supported by the same vehicle. In one example, each of the treatment modules 504 can share the same chemical selection component 526. In one example, multiple chemical selection units 526 can be configured to connect and interface with each treatment module 504 where one treatment module 504 can be configured with one chemical selection unit 526.

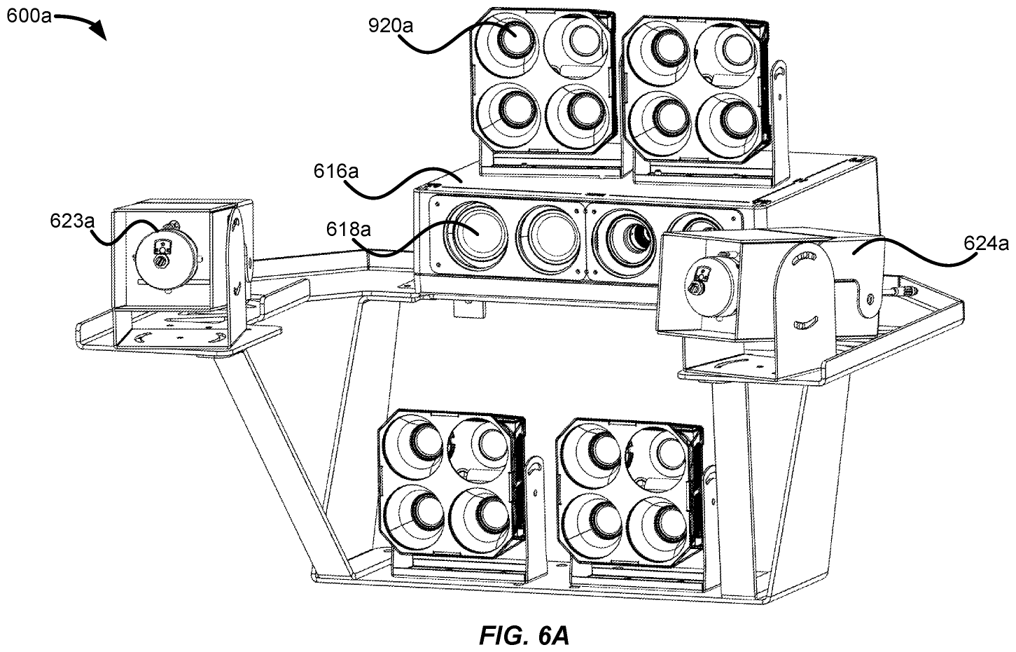

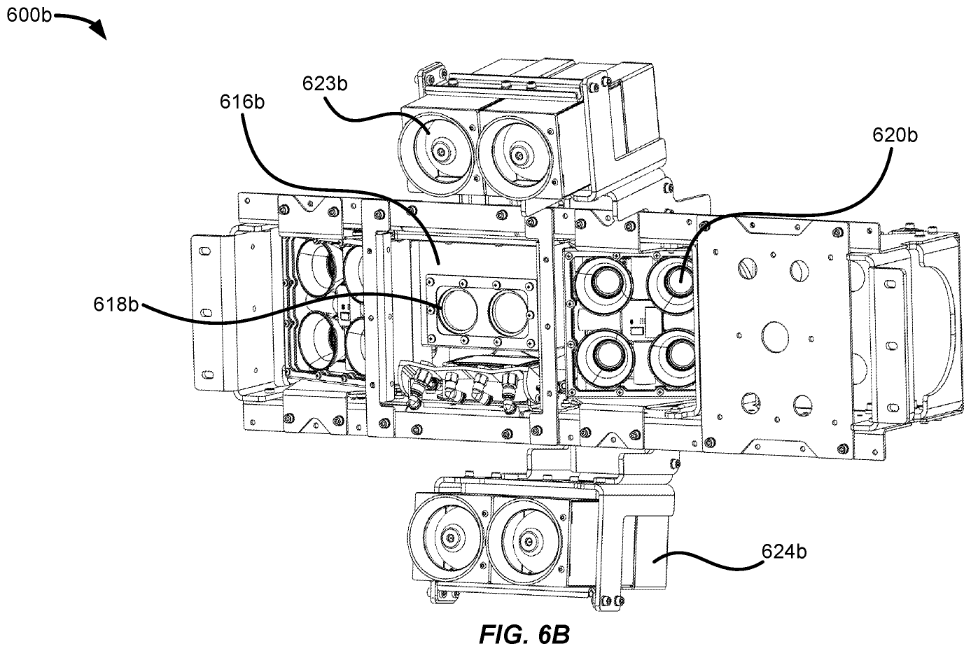

FIGS. 6A and 6B illustrate example configurations of an example modular treatment modules. The module treatment module 600a can include a support structure and components supported by or embedded in the support structure, including a treatment unit 623a and a treatment unit support structure 624a, one or more image sensors 618a including a compute unit and image sensor box or enclosure 616a, and one or more illumination units 620a having one or more LED Lights with one or more lenses.

In FIG. 6B, the module treatment module 600b can include a support structure and components supported by or embedded in the support structure, including a treatment unit 623b and a treatment unit support structure 624b, one or more image sensors 618b including a compute unit and image sensor box or enclosure 616b, and one or more illumination units 620b having one or more LED Lights with one or more lenses.

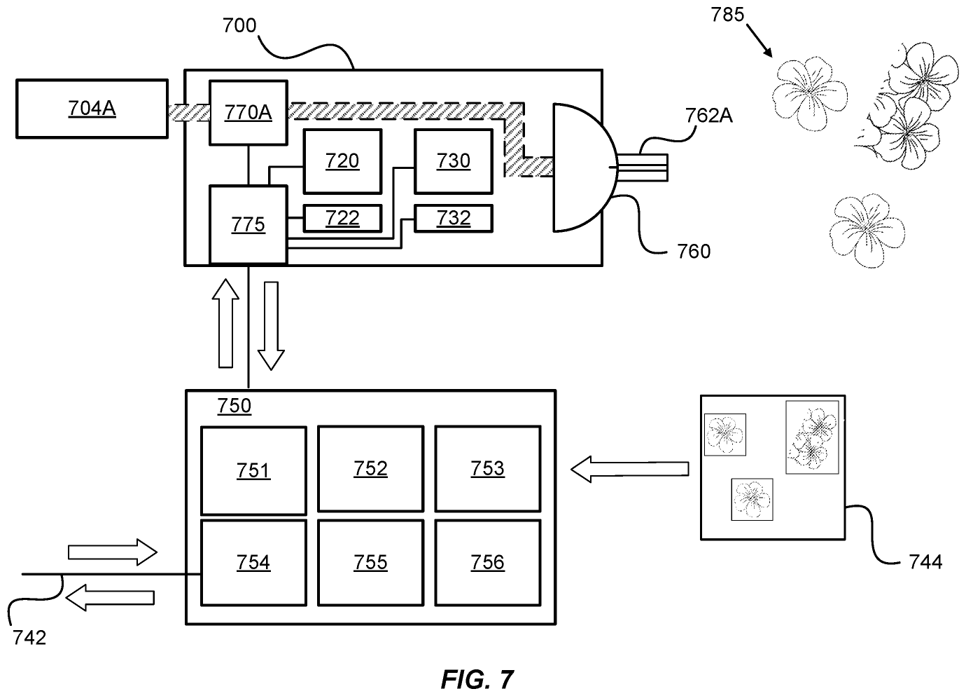

FIG. 7 is a block diagram illustrating an example configuration of the system with treatment unit 700 configured for various fluid source and spraying tip options as well as light source and laser emitting tip options. In one example, the agricultural treatment system has onboard circuitry, processors and sensors that allows the system to obtain imagery of agricultural objects and then identify a target object to be sprayed. Furthermore, the agricultural treatment system has onboard circuitry, process and sensors that allows the system to determine position of the vehicle and/or treatment unit in a three-dimensional space. Moreover, the agricultural treatment system includes other cameras and computer vision sensor to obtain and process imagery of external real-world objects 784. For example, block 750 illustrates a subsystem having a computer unit 751, communication channel 754, cameras 753, machine learning model and computer vision algorithm 755, lights 756, and other sensors 752. For example, the system may use GPS location data, IMU data to identify inertial movement and distance moved. Over a period of time, the system may determine multiple poses of the vehicle and/or treatment unit and convert/translate these poses that the spraying head would need to be positioned into such that the spraying head would maintain an emit spray at the target object while the vehicle is moving.

The subsystem 750 interacts with a treatment unit 700. While a single treatment unit is shown, the subsystem 750 may interact with and control multiple treatment units. Generally, the treatment unit 700 includes a microcontroller that is operably coupled with one or more solenoids 770, pumps, multiple motors 720, 730 and multiple encoders 722, 732. The treatment unit 700 may draw fluid from one or more source tanks 704. The subsystem 750 may communication via communications channel 742 with another computer system. For example, the subsystem 750 may receive global registry information and data (e.g., global registry information such as GPS location data, IMU data, VSLAM data, etc.)

The microcontroller 775 may control or interact with the pump, solenoid 770A, motors 720, 730 and encoders 722, 732 to position the treatment head assembly 760 and emit fluid from one or more fluid sources. For example, based on interaction with the subsystem 750, the treatment unit 700 may control the position of a treatment head assembly 760 to orient the treatment head assembly 760 such that the treatment head assembly 760 may emit a fluid at a target object 785. In one example, the system includes a treatment unit with a single fluid source tank 704A and a single solenoid 770A, and a spraying head 762A with a single port.

In one example, the treatment unit 700 can include multiple fluid sources that may be combined or mixed with a primary fluid source. The micro controller 775 may operate a solenoid 770A to control the flow of a primary fluid source, such as water. The primary fluid source may then be combined with one or more secondary fluid sources disposed near the treatment head. The secondary fluid sources may be concentrated chemicals or fertilizers that are mixed with the primary fluid source to dilute the concentrated chemicals and create a chemical mixture as the primary fluid source travels close to the end of the line from a tank, to the treatment head assembly 760. While not shown, each of the secondary fluid sources may be controlled via separate solenoids and pumps to cause the secondary fluid sources to disperse fluid from a tank. The combined mixture of the primary fluid source and the one or more secondary fluid sources are then emitted via the spraying head assembly 760 via spraying tip 762A with a single port.

In one example, the system, both the navigation system and its components, sensors, and compute units, as well as each component subsystem or component treatment module having its own components, sensors, treatment units, and compute units, can use techniques associate with simultaneous localization and mapping (SLAM) and odometry, particularly visual SLAM, VSLAM, and visual odometry, or VIO, in conjunction with other non-visual based navigation and localization analysis, fused together in real time with sensor fusion and synchronization, to perform pose estimation of the vehicle. Additionally, each modular sub systems of the treatment system including each modular spray subsystem, for example each modular spray subsystem or component treatment module including a structural mechanism, a compute unit, one or more sensors, one or more treatment units, and one or more illumination devices, can perform VSLAM and receive other non-visual based sensor readings, and continuously generate its own localized pose estimation, the pose being relative to specific objects detected by each of the component treatment modules, which can include agricultural objects including target objects or nearby objects or patterns, shapes, points, or a combination thereof that are of a similar size to that of the target objects. The pose estimation of components of each of the component treatment modules will be relative to the location of the objects and patterns detected to be tracked across time and across sensors in stereo for stereo matching points for depth perception. Additionally, the system can perform projection and reprojection, and determine reprojection error, for more accurately determining location of objects and eliminating outliers. Thus, detecting objects and patterns that are known to be fixed in space, for example a ground terrain with unique rocks or dirt patterns, or individual plants, and calculating and identifying the objects' or patterns' 3D location and/or orientation relative to the sensors' 3D location and/or orientation sensing the objects and patterns allows the system to understand navigation, localization, and more specifically local pose estimation of each of those sensors relative to the objects detected. Additionally, since the orientation of the treatment units, and its treatment heads, are in close proximity to the individual component treatment module, and rigidly attached and connected to a structure of the component treatment module and also in close proximity and rigidly connected to the sensors associated with that particular component treatment module and compute unit, the location and orientation of the treatment head of the treatment units (the treatment heads having encoders to determine line of sight relative to the body of the treatment unit) can also be continuously generated and determined relative to the target objects or objects near the target objects themselves for better accuracy of treatment.

In this disclosure, while the determined pose estimation can be referred to the pose estimation generated for the vehicle or a component modular spray subsystem, a pose estimation can be determined, using VSLAM, VIO, and/or other sensor analysis, to generate a pose, including a location and/or orientation for any component of the vehicle or component of the agricultural observation and treatment system. In one example, a pose estimation can be referred to and generated with coordinates, for example (x₁, y₁, z₁, Φ₁, θ₁, Ψ₁) with x, y, z, being the translational location relative to an origin (x₀, y₀, z₀) and starting orientation (Φ₀, θ₀, Ψ₀) of the component relative to an origin point and/or orientation, of any component or portion of a component.

In one example, to identify target objects for spraying, the system may compare at least a portion of the identified images by comparing the sub-key frame image to a portion of one of the captured images. In other words, the agricultural treatment system can compare one or more patches or labeled portions of a previously indexed image of an agricultural object with at least a portion of the currently captured image. In this example, a patch is an image cropped out of a bigger image having one or more features of interest. The features of interest in the bigger image captured by image sensors can include agricultural objects, landmarks, scenes or other objects of interest to be identified, labelled, and assigned a unique identifier or marker to be indexed. For example, a bounding box of an image, or other shape, can be drawn around a portion of an image, cropped out and separately indexed by the agricultural treatment system and saved as a patch for comparing against captured images taken in the future, for building a digitized map of a geographic boundary, for associating an object captured during one trial with the same object captured at different trials, or a combination thereof. The system determines a confidence level of whether the sub-key frame image matches the portion of the captured image. The system identifies a match where the determined confidence level meets or exceeds a predetermined confidence level threshold value. In one example, various computer vision techniques can be applied to compare and correspond images and determine similar features for matching. This can include template matching for comparing a portion of an image with the region of interest of another image, normalized cross correlation, random sample consensus (RANSAC), scale-invariant feature transform (SIFT), FAST, edge orientation histograms, histogram of oriented gradients, gradient location and orientation histogram (GLOH), ridge and edge detection, corner detection, blob detection, line detection, optical flow, Lucas-Kanade method, semantic segmentation, correspondence matching, and other computer vision and matching techniques. The system may identify that a captured image includes a target object to be treated or a target object that was already sprayed and does not currently need a treatment based on features detected of the agricultural object, based on its treatment history, or a combination thereof. Based on determining the location of the image sensors of the agricultural treatment system, the location of the target object in the obtained image, the system can then configure, orient, and prepare the treatment unit such that a fluid projectile when emitted, would be sprayed in a trajectory to emit fluid onto the real-world targeted agriculture object.

In another example, the system may use landmark features or objects to determine locations of target objects to be sprayed. The landmark objects are real-world objects that aid in determining the location of a target object. The system may identify a landmark object in a captured image and determine a portion of the landmark object in the capture image matches a portion of an image from the group of images. While not intended to be an exhaustive list, examples of landmark object may include a man-made object, a fence, a pole, a structure, a portion of a plant structure, a portion of a tree structure, a leaf formation or a leaf cluster that can be used to mark a specific location of a geographic boundary or distinguish a specific keyframe for having the unique landmark assigned to the portion of the keyframe.

In another example, in one mode of operation, in a first pass along a path along an agricultural environment, the agricultural treatment system obtains a first set of multiple images while the system moves along the path. For example, the agricultural treatment system uses onboard cameras and obtains multiple digital images of agricultural objects (e.g., plants, trees, crops, etc.). While obtaining the multiple images of the agricultural objects, the agricultural treatment system records positional and sensor information and associates this information for each of the obtained images. Some of this information may include geo-spatial location data (e.g., GPS coordinates), temperature data, time of day, humidity data, etc. The agricultural treatment system or an external system (such as a cloud-based service) may further process the obtained images to identify and classify objects found in the images. The processed images may then be stored on a local data storage device of the agricultural treatment system.

For example, the processed images received by the treatment system, may have associated positional information. As the agricultural treatment system moves along the path in the second pass, the agricultural treatment system may compare a subset or grouping of the processed images based on location information associated with the processed images, and a then current position or location of the treatment system. The agricultural treatment system compares new images to the processed images and determines whether the images or a portion of the images are similar. The agricultural treatment system may then identify a location to spray based on a likely location of a target object in the processed images.

In one example, to perform better VSLAM in an agricultural scene, certain objects that are landmarks that are tracked across time can improve the quality of VSLAM and pose estimation, for example, large enough stationary objects typically found in the specific agricultural scene. Landmarks can be used to identify which frames are of interest to store, store as a keyframe (because one does not need so many frames at once all having the same fruits, or detected objects, from frame to frame), and to be used to identify objects in real time and tracked for visual based navigation and mapping including VSLAM. Because there are spatial locations to each of the objects, landmarks, and it' unique identifying characteristic. In one example, tree trunk 1336 can be detected, by a machine learning algorithm or programmatically predefined as stationary dark objects that protrude from the ground. Detection and tracking tree trunks in an orchard can allow a system to partition an agricultural environment by the trees themselves, such as to minimize error in detecting one cluster of objects and thinking its origin is at once place, when it should be at another. For example, a system can detect a first tree trunk having a first location in global scene, as well as determine a pose of the system itself relative to the tree trunk detected. The system will also detect a plurality of objects, including its identity as well as whether that unique object was detected before either with the same identifier, or a different identifier, being that the phenological state of the object has changed, but still the same object in space. In this example, the system can associate a cluster of objects detected, being on the same tree, with the tree trunk detected. In this case, if the system incorrectly detects other objects or landmarks at different and nearby trees due to its pattern being similar to a previously identified pattern or object, and it's location based sensors are not accurate which the change in location was not detected from a first object, pattern or landmark located near a first tree trunk and a second object, pattern, or landmark located at a second tree trunk, for example if the GPS sensor is off by a few meters or did not update in time, An additional checking point for the system can be detecting a first tree trunk and a second tree trunk. Because the system knows that two different tree trunks must be far enough apart from each other, the system can determine that a previously detected object determined to be a certain location is likely wrong due to the system also determining that the object detected was in proximity to another tree trunk that could not have been located at a different location.

While tree trunks are unique to orchards, any large, stationary objects or patters that are unique to the specific geographic environment can be programmatically detected to better improve spray performance, navigation performance, and mapping of the scene. For example, detecting beds, troughs, furrows, and tracks of a row crop farm can be used to improve performance of observing and performing actions in the row crop farm. The techniques used can be a combination of computer vision, machine learning, or machine learning assisted techniques in detecting beds, troughs, furrows, and tracks such as long lines in a captured frame, differences in depth between lines (for example tracks and beds will have substantially the same line pattern because they are next to each other but have different depths), which can be detected with depth sensing techniques and detecting changes in color between beds and tracks, for example.

In one example, the object determination and object spraying engine generates positional data for an instance of the fruit at a particular stage of growth that is portrayed in a captured image based in part on: (i) a pixel position of the portrayal of the instance of a fruit at the particular stage of growth in the labeled image (and/or the captured image), (ii) the position information of the moving vehicle, and/or (iii) previously generated position information associated with a previous captured image(s) of the instance of the fruit and the physical location of the instance of the fruit. Previously generated position information may be associated with captured and labeled images that portray the same instance of the fruit when the vehicle traveled a similar route during a previous time, such as a prior hour of the day, prior day, week and/or month. The agricultural treatment system may generate nozzle signals for the synchronization ECU of the agricultural treatment system on a vehicle based on the positional data for the instance of the fruit at the particular stage of growth. For example, the nozzle signals may indicate a physical orientation of the nozzle to create a trajectory for a liquid. The nozzle signals may represent a change in a current orientation of the nozzle based one or more axial adjustments of the nozzle.

The object determination and object spraying engine sends the projectile from the nozzle towards the physical location of the object according to the trajectory. For example, the object determination and object spraying engine adjusts a current orientation of the nozzle according to the nozzle signals and triggers the nozzle to spray a liquid towards the physical location of the instance of the fruit.

Because not all plants need the same amount, for example by type, volume, frequency, or a combination thereof, of treatment based on the stage of growth of the particular plant, the agricultural treatment system can be configured to scan a row of crops to identify the stage of growth of each individual crop or agricultural object that is a plant or portion of a plant and determine whether the identified crop or agricultural object needs a treatment on the particular trial run, or day, or at the particular moment in time the vehicle with agricultural treatment system is on the field and has detected the individual agricultural object. For example, a row of crops, even of the same kind of plant, can have a plurality of agricultural objects and sub-agricultural objects of the agricultural objects, where the agricultural object may depict different physical attributes such as shapes, size, color, density, etc.

For example, a plant for growing a particular type of fruit, in one agricultural cycle, can produce one or more individual crop units, for example a fruit tree, each taking the shape of a first type of bud, second type of bud, and so forth, a flower, a blossom, a fruitlet, and eventually a fruit, depending on a growth stage of a particular crop. In this example, the agricultural treatment system can label each stage of the same identified object or crop, down to the particular individual bud, on the fruit tree as different agricultural objects or sub agricultural objects, as the object changes in its growth stage including its particular shape, size, color, density, and other factors that indicate a growth into a crop. The different agricultural objects detected and labelled associated with the same object in the real-world space can be associated with each other

Thus, the agricultural treatment system can, in real time, scan with sensors for agricultural objects and its stage of growth and real—world location in the row, determine whether to apply a particular treatment based on stage of growth detected and the particular agricultural object's treatment history.

In one example, the agricultural observation and treatment system can be configured to detect objects in real time as image or lidar sensors are receiving image capture data. The treatment system can, in real time, detect objects in a given image, determine the real-world location of the object, instruct the treatment unit to perform an action, detect the action (discussed below), and index the action as well as the detection of the object into a database. Additionally, the treatment system, at a server or edge computing device offline, can detect objects in a given image, spray projectiles, spray action, spot of splat detections, and index the object detections and spray action detections. In one example, the agricultural observation and treatment system can perform and use various techniques and compute algorithms for perform the object detections including computer vision techniques, machine learning or machine learning assisted techniques, or a combination thereof in multiple sequences and layers such that one algorithm partitions a given image and a second algorithm can analyze the partitioned image for objects or landmarks.

In one example, a machine learning model, embedded in one or more compute units of the agricultural observation and treatment system onboard a vehicle, can perform various machine learning algorithms to detect objects, including object detection including feature detection, extraction and classification, image classification, instance classification and segmentation, semantic segmentation, superpixel segmentation, bounding box object detections, and other techniques to analyze a given image for detecting features within the image. In one example, multiple techniques can be used at different layers or portions of the image to better classify and more efficiently use computer resources on images. Additionally, pixel segmentation can be performed to partition colors in an image without specific knowledge of objects. For, example, for row crop farming, a system can perform color segmentation on a given image to partition detected pixels associated with a desired color from any other pixels into two groups, such as the color segmented pixels and background pixels. For example, a system can be configured to analyze frames by detecting vegetation, which can be a form of green or purple color from background objects, such as terrain, dirt, ground, bed, gravel, rocks, etc. In one example, the color segmentation itself can be performed by a machine learning model configured to detect a specific type of color in each pixel ingested by an image sensor. In another example, the color segmentation can be manually predefined as pixels ranging between a specific range of a color format. For example, vegetation algorithm can be configured to analyze a given frame to partition any pixels having attributes of the color “green” form a Bayer filter. In another example, the algorithm can be configured to detect attributes of “green” under any color model where “green” is defined. For example, a numeric representation of RGB color being (r,g,b) where the value of g>0 in any digital number-bit per channel. The algorithm can itself be a machine learning algorithm to detect “green” or a different color that are of interest.

In one example, machine learning and other various computer vision algorithms can be configured to draw bounding boxes to label portions of images with objects of interest from backgrounds of images, masking functions to separate background and regions of interest or objects of interest in a given image or portion of an image or between two images where one image is a first frame and another image is a subsequent frame captured by the same image sensor at different times, perform semantic segmentation to all pixels or a region of pixels of an given image frame to classify each pixel as part of one or more different target objects, other objects of interest, or background and associate its specific location in space relative to the a component of the treatment system and the vehicle supporting the treatment system.

Multiple techniques can be performed in layers to the same or portions of the same image. For example, a computer vision technique or machine learning technique can be first applied to an image to perform color segmentation. Once a given image is detected and pixels related to a desired or target color is segmented, the separate machine learning algorithm or computer vision algorithm can be applied to the segmented image, for example to an object detection algorithm to draw bounding boxes around the segmented image containing weeds and containing crops. In another example, an object detection algorithm can be applied to the entire image to draw bounding boxes around plants of interest, such as crops and weeds. Once the image has bounding box detections draw around each of the detected crop or weed objects in the image, a color segmentation algorithm can be applied to just those bounding boxes to separate pixels bounded by the box that are of a target color, such as green, and those pixels that are considered background. This method can allow a system to more accurately determine which pixels are associated with objects in the real world, such that an image with contours and outlines of a specific object detected in the image, such as a leaf, can be a more accurate depiction of the leaf, and therefore more accurately target the leaf in the real world, than drawing a rectangular box around a leaf where the system determines that any portion inside the bounded rectangular box is associated with the object “leaf”. The example above is just one of many examples, configurations, orders, layers, and algorithms, that can be deployed to analyze a given image for better understanding of objects, that is improved feature detection, performed either online in the field in real time, or offline at a server for other uses, such as creating a time lapse visualization, mapping the object, generating key frames with detections for indexing and storage, diagnosing and improving machine learning models, etc.

In one example, detecting a plurality of agricultural objects and/or landmarks can be used to perform variations of consensus classification. For example, multiple detections of the same agricultural object and/or landmark can be performed to eliminate or reduce false positives or false negatives of object detection. While a machine learning model will be tasked to identify individual objects and landmarks, the closeness of an object to another object in a single frame can also be accounted for an considered by the machine learning detector for detecting an object. For example, if in a first frame, the machine learning detector detects a target object as well as a plurality of nearby target objects, other agricultural objects, or landmarks, but then in subsequent frames, while the vehicle has not moved enough such that the location where the ML detector has detected a target object has not moved out of the next frame, does not detect that same target object, but does detect all of the other nearby target objects, other agricultural objects and landmarks detected in the first frame, the compute unit can determine that the first frame may have had a false positive and flag the frame for review and labelling, at a later time on board the vehicle for a human to label, or offline, without instructing the treatment unit to perform an action at the location in the real world where the system detected a target object to treat based on the first frame.

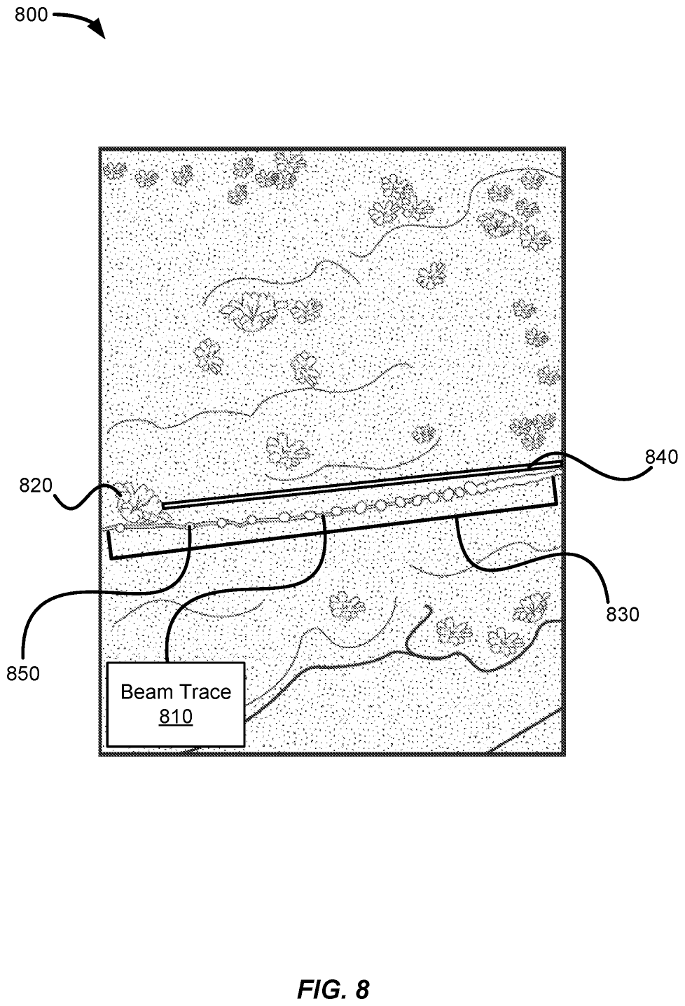

FIG. 8 is a diagram 800 capturing an action performed by an observation and treatment system. In this example, an image capture device can receive a constant stream of images of a local scene having one or more agricultural objects in the scene. Once a target object is detected, targeted, and tracked, the system will instruct a treatment unit to activate and emit a liquid projectile or a beam of light onto a surface of the target object. This action will take a length of time to release from the treatment unit to exiting the treatment head, travel in space, hit the target if accurately targeted and emission parameters, such as dwell time which is the amount of time the nozzle head is pointed at the target object while the nozzle head is on a moving vehicle, pressure release time which is when a pressure actuator such as a capacitor or solenoid valve opens and closes and allows pressurized fluid to release from the valve and through the nozzle head, nozzle orifice size, and other parameters, and create splash, splat, or a footprint on the ground for row crops where plants, or target plants, are growing out from the ground.

In this example, the image capture system can capture and trace the liquid projectile itself, for example fluid projectile 830. Because the projectile is a fluid, it may not flow it an exact straight line. Additionally, the projectile can be comprised of smaller liquid droplets 850. The compute unit and image sensors can detect the beam trace directly from detecting the projectile 830 and its smaller droplets 850 as the liquid leaves the treatment unit. Additionally, a laser with a laser beam 840 can be pointed at the intended target object 820 for the system to detect both the laser beam and trace the projectile beam to determine whether there was a hit, and if there was any error or discrepancy form the desired projectile hit location to the actual trajectory of the projectile.

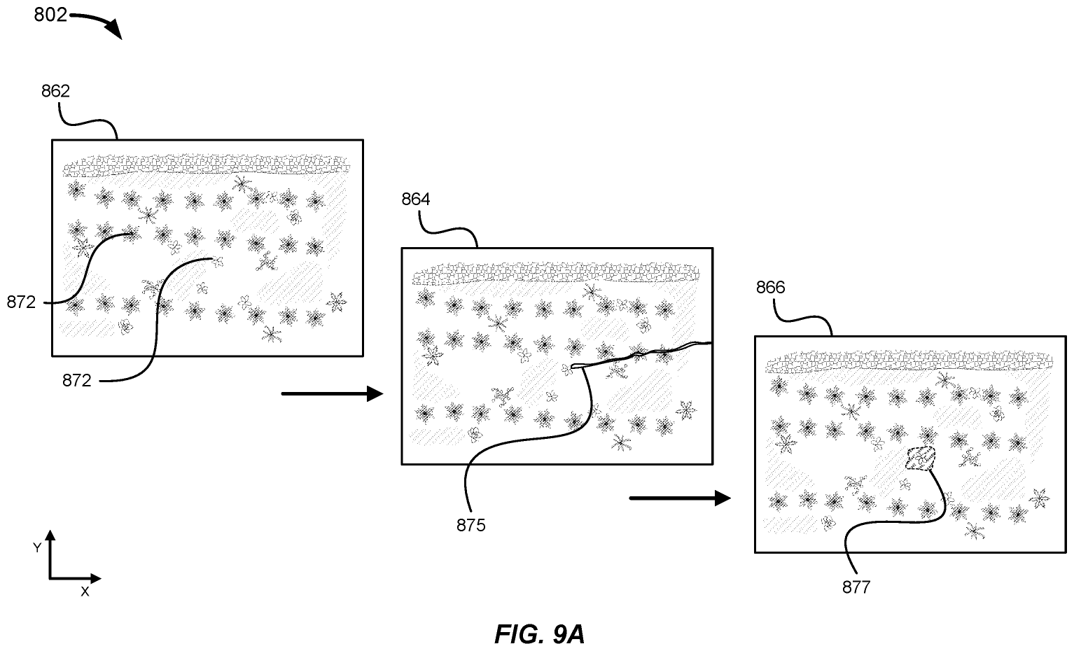

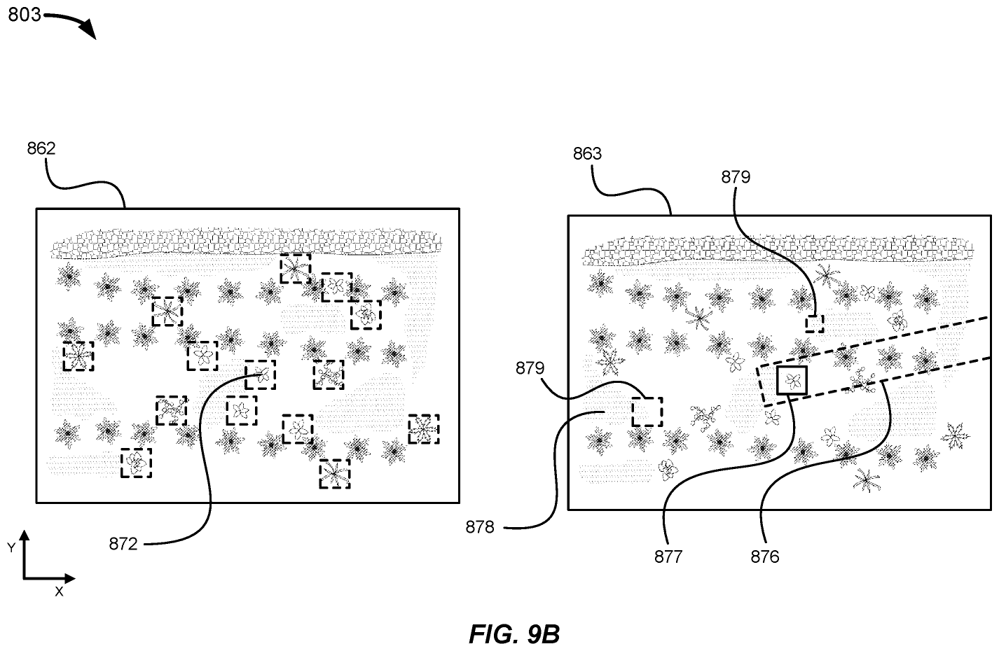

FIG. 9A and FIG. 9B illustrate an example of spray detection, beam detection, or spray projectile detection. In these diagrams 802 and 803, one or more image sensors is scanning a local scene comprising a plurality of plants 872 including target plants for treatment and crop plants for observation and indexing. As the sensor scans the scene while a vehicle supporting the sensor is moving in a lateral direction, the sensor will capture one or more image frames in sequence from one to another illustrated in image frames 862, 864, and 866 where image frame 864 and 866 are frames captured by a sensor that captured image frame 862 subsequently, but not necessarily the immediate next frame captured by the image sensor. During the capturing of images, if component treatment system having sensors and treatment units sends instructions to the treatment unit to perform a spray action, such as emit a fluid projectile, the image sensors would capture the spray action as it comes into the frame and then eventually disappears as the projectile is fully splashed onto the surface of the intended target or ground. In such example, the spray projectile, such as projectile 875, can be detected and indexed by the image sensors and the treatment system, as well as the splat area 877 after the spray has completed. The system can detect the splat size and location.

In one example, the detection of the spray can be performed by various computer vision techniques including spray segmentation, color segmentation, object detection and segmentation, statistical analysis including line fitting, homography estimation, or estimation of a homography matrix, or a combination thereof. For example, the differences between frame 862 and frame 864 can be the presence of a spray and the lack of presence of a spray. The rest being the same features in each image. In one example, homography estimation is used to account for change in space across a common plane, such as a bed of a row crop farm. A homography matrix can be used to estimate how much movement in space from a first frame to a subsequent frame. The images will be slightly misaligned from each other due to the camera being on a moving vehicle while the first frame 862 is captured and a subsequent frame 864 is captured. The discrepancy in in the frames caused by the motion of the camera can be accounted for with homography estimation, given that the two frames are likely looking at the same plane of equal distance from the camera from the first frame 862 to the subsequent frame 864, at a later time but not necessarily the exact next frame captured by the image capture device. The difference in the two images, other than the discrepancy which can be accounted for by homography estimation, would be the presence of the spray, which can be generated by comparing the two frames and performing spray segmentation, that is the pixels in frame 864 that has the spray projectile 875 captured compared to the pixels in frame 862 that do not have a projectile detected. In this case, one or more statistical and image analysis techniques, including line fitting, and masking function to determine that the pixels detected in frame 864 but not detected in frame 862 is a spray projectile. Since spray projectiles are likely line shaped, the pixels related to the spray can be line fitted. Other image differential techniques can be applied to detect the spray beam including outlier rejection and using priors for masking outliers. The priors can be an expected region such as that outline by predicted spray path 876. In one example, the difference in pixels profiles detected from a first frame to a subsequent frame, accounting for homography estimation due to changes in translation of the image sensor, can generate a projectile segmentation. Similar techniques can be used to detect the splat or spot detection of the spray outcome onto the surface of the target and ground, for example, seeing the color of the ground and target plant change from unsprayed to sprayed. For example, a liquid projectile hitting a target plant will morph from a projectile having a small cross-sectional diameter to a flat area covering a portion of the dirt or leaf. In this example a liquid projectile may change the color of the dirt surrounding a plant, due to dry dirt turning wet from the liquid projectile hitting the dirt. In this case, the image sensors can detect a color change in the ground and determine that a splat is detected and that a detect target object for treatment has been treated, and logged or indexed by the treatment system. In one example, a stereo pair of cameras can detect sprays in each camera and associated with each other to fit a 3D line such that the system can detect and index a spray in the real world with 3D coordinates.

FIG. 9B. illustrates a diagram 803 to determine spray accuracy and spray health, spray health being whether external factors outside or correctly detecting target object and lining the treatment head onto the target object and tracking it as the target object moves away from the treatment unit, since the treatment unit is on a moving vehicle, a prior or predicted spray path 876 can be generated. For example, a sensor, disposed on a moving vehicle, can receive an image frame 862 having a plurality of crop objects and target objects, including detected target object 872. The treatment system will target the target object 872, track the object 872 in subsequent frames, such as that of frame 862, and emit a projectile onto target 872. In one example, due to external factors not necessarily related to computer vision, such as portions of the treatment unit no longer calibrated to the image sensor, such that targeting at a specific location in the real world from a detection in the image frame may result in a misalignment of the line of sight of the treatment head. For example, the treatment system, given frame 862 or 862, may target the target object 872 at the correct real-world location, but in doing so and instructing the treatment head to aim its nozzle to target object 872 in the real world may in fact be targeting a location 879 or 878, or an incorrect location or misaligned location in the real world, that the treatment systems image sensor would capture. In this case, to quality check the spray targeting and spray action, the treatment system can predetermine a predicted spray path 876 and perform spray segmentation and other computer vision and machine learning techniques described above only in the portion of the image, and therefore compare pixels related to the images contained in the region defined by the predicted spray path 876. If the detection is not good enough, such as the line cannot be fitted, the system can determine that the spray did not happen, or happened but not at the intended target. Alternatively, the system can perform spray segmentation on the spray that was detected, whether within the predicted spray path 876 or not, and determine whether the end of the spray or the splat detected lines up with the intended target. Thus, seeing where a target object should have been sprayed, and/or should have had a splat detected, and where the actual spray profile was detected, including 3D location, and where the spray splat was detected, can be used to evaluate the specific spray health of that particular spray, and whether intrinsic or extrinsic adjustments needs to be made. The adjustments can be accounting for wind that may have moved the spray, the speed of the vehicle not being accounted for properly as the system tracks an object from frame to frame, or mechanical defects such that the intended target and the line of sight after sending the correct instructions to orient the treatment head of the treatment unit are misaligned. Upon detecting an inaccurate or incorrect spray projectile, one or more of the discussed defects can be accounted for in real time and a second projectile can be reapplied on to the target object and tracked again for trajectory evaluation and its spray health and accuracy.

Additionally, a method may be performed by some example systems or subsystems described in this disclosure either online, that is onboard a vehicle supporting one or more modular agricultural observation and treatment systems, subsystems, or components of systems, or offline, that is at one or more servers or edge compute devices.

The observation and treatment system or server can identify a first object for treatment. In this example, the observation and treatment system or a server is analyzing the performance of the online observation and treatment system during its latest run, in a location such as an agricultural geographic boundary. The system, online or at a server, can identify each treatment performed or instructed to be performed on the geographic boundary for verification, indexing, and adding the verification to each of the identified target object's treatment history. For example, a treatment system may have identified and initialized a few thousand or a few hundred thousand actions performed in a single run at a field, orchard, or farm, and a server is analyzing the treatment accuracy and efficacy of each of the actions performed on the field in that particular run. The observation and treatment system or server can determine a treatment unit activation for each of the objects for treatment. The system or server can determine treatment actions based on the treatment performed and logged previously in real time while the observation and treatment system was on the field performing detection objects and performing treatments. In this example, the server does not have to identify every frame captured and determine which objects detected were treated for second time, but instead can analyze only those frames captured by image capture devices where each online and onboard compute unit has already detected. In one example, the determining of treatment activation can include the treatment parameters such as desired spray size, volume, concentration, mixture of spray content, spray time of flight, etc.

The observation and treatment system or server can detect a first emission pattern. This can be done with techniques described above as well as image correspondence from a previous frame and a subsequent frame to detect a projectile.

The observation and treatment system or server can index the first emission pattern. This can be stored as a 3D vector, or a 2D or 3D model of the full 3D profile with shape and orientation mapped into a virtual scene.

The observation and treatment system or server can detect a first treatment pattern. This can be the splat detection from color change in dirt from a first frame to a subsequent frame, performed by similar methods described above.

The observation and treatment system or server can index the first treatment pattern.

The observation and treatment system or server can determine and index the first object as treated. For visualization purposes, a target object that has not been accurately treated can have a bounding box with a dotted line indicating a detection of the object itself but no detection of a spray onto that target object. And once a spray or treatment is detected, by the projectile or the splat detection, the dotted line can convert to a solid line, as illustrated in diagram 803 of FIG. 8C.

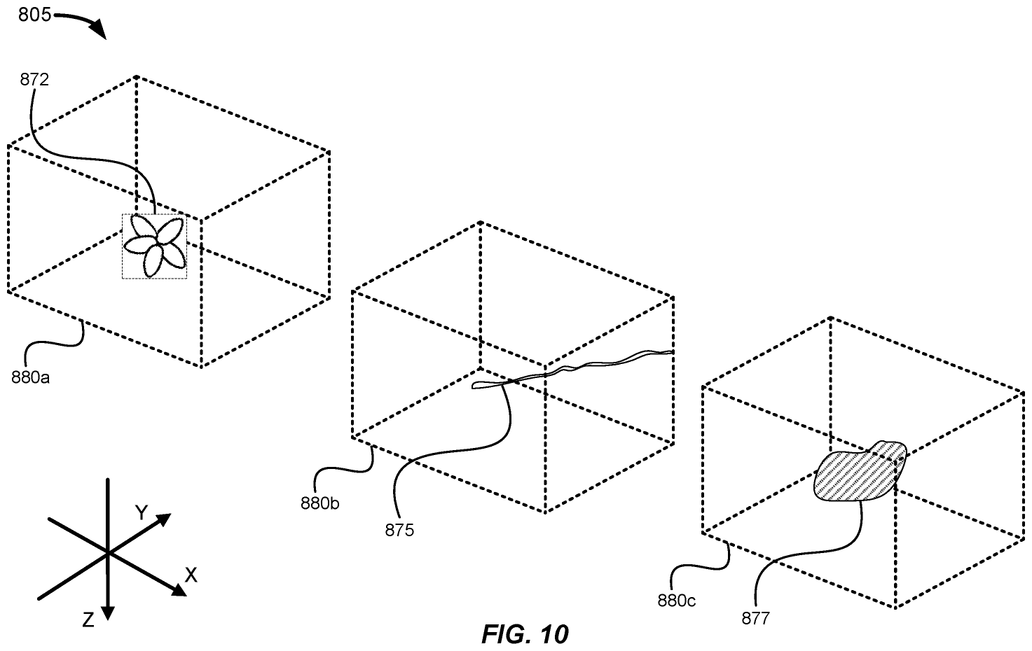

Each spray projectile and splat detections can be indexed and visually displayed in a user interface. As illustrated in FIG. 10, the 2D or 3D models 880a, 880b, and 880c of each target object 872, spray projectile 875, and splash pattern 877 onto a surface of the ground and target object. Additionally, the 3D models can be superimposed on each other to reconstruct the spray action from the targeting of the target object, to the spraying of the target object, to the splash made and splat detected.

The agricultural treatment system may monitor and evaluate the treatment of agricultural object. The treatment system is configured to capture images of the emitted fluid projectile and determine where the emitted fluid projectile had been sprayed and/or where the emitted fluid projectile had impacted onto a surface (such as an agricultural object or ground area about the agricultural object.)

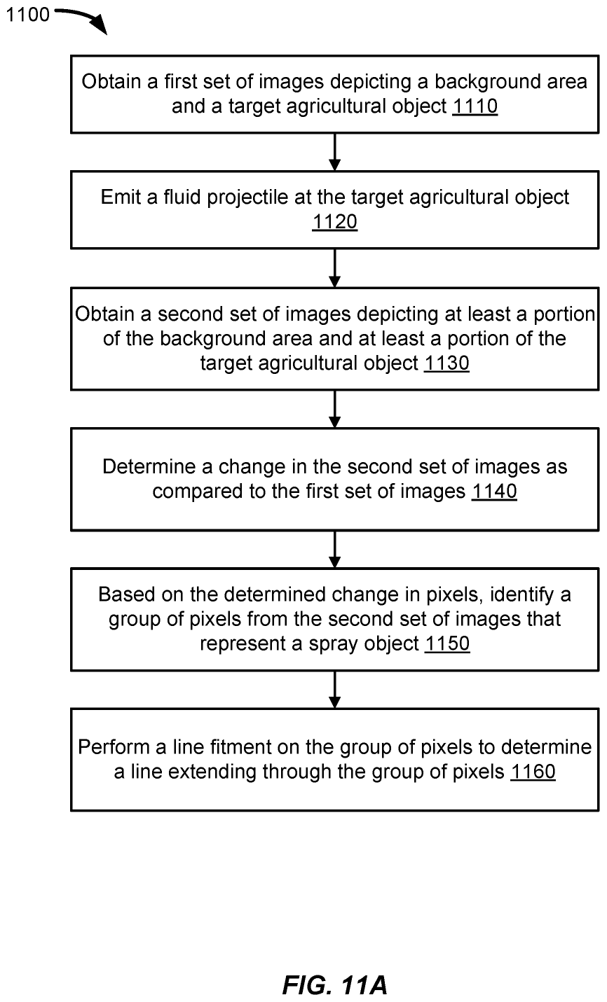

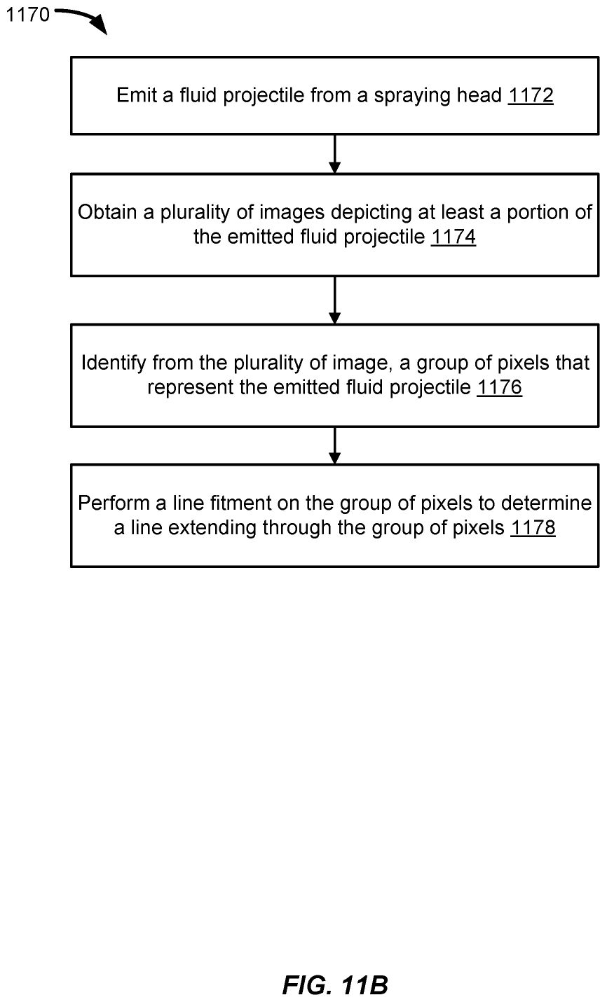

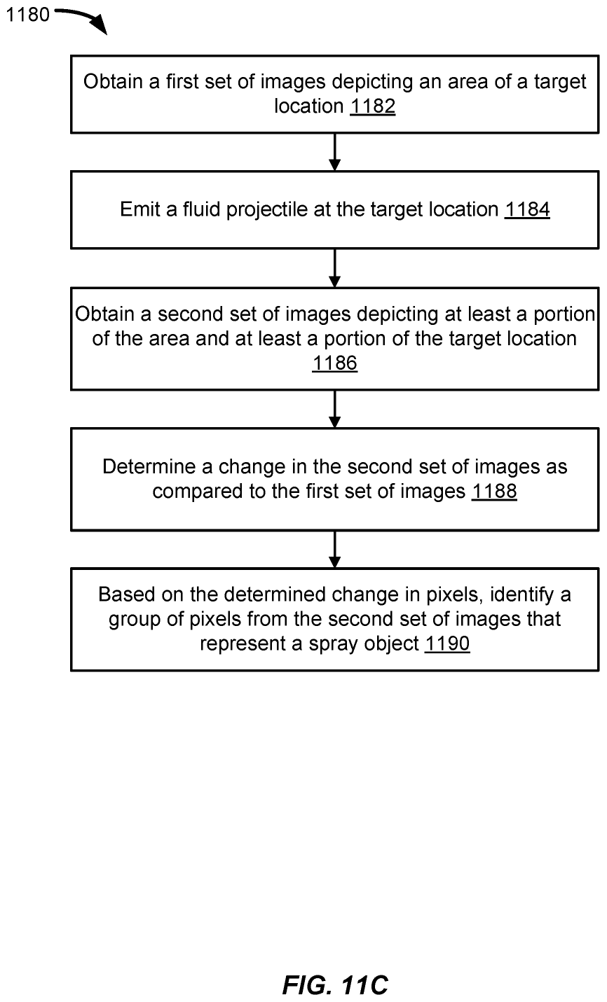

FIG. 11A illustrates example implementations of method 1100 that may be performed by some embodiments of the system described above, including system 100, agricultural treatment system 400, system 600, and system 800. At step 1110, the system obtains a first set of images depicting a background area. The system obtains with one or more image sensors at a first time period a first set of images. The first image includes multiple pixels depicting a background area and an agricultural object positioned in the ground area. The first image may be obtained prior to the emitting of a fluid projectile. At step 1120, the system then emits a fluid projectile of a fluid at a first target agricultural object. For example, the system may position a spraying head and then may emit a fluid projectile from the spraying head at the first target agricultural object. At step 1130, the system obtains a second set of images depicting at least a portion of the background area and at least a portion of the target agricultural object. the system obtains with the image sensor at a second time period after the first time period, a second image including a plurality of pixels depicting the ground area and the agricultural object. The second image includes at least a portion of the same ground area and the same agricultural object as depicted in the first image.

At step 1140, the system determines a change in the second set of images as compared to the first set of images. For example, the system may compare the first image with the second image to determine a change in pixels between the first image and the second image. The first and second images may be compared to one another using various imaging comparison techniques to extract or identifying pixels in the second image that are different in pixel values (e.g., color values of 0-255). The system may perform a pixel alignment process to align common pixels or patterns or areas of the first and second images. The comparison of the images is meant to identify changes in the second image to indicate a spray impact on a ground, a spray impact on the agricultural object and/or a pixels depicting an emitted spray projectile. One skilled in the art would appreciate that pixel comparison techniques may be used, such as pixel comparison by cluster, shape and/or pattern, pixel comparison by pixel values (such as an r value, g value, b value in an RGB color space). While not meant to be an exhaustive listing, some image comparison techniques that may be used include strict comparison, Hough transform, machine learning image processing, fuzzy pixel comparison, histogram comparison, correlation comparison, image masking, feature extraction, or any other pixel or object extraction known to one skilled in the art. In one example, a fluid sprayed onto an agricultural object or a ground area around the agricultural object (such onto dirt), may cause the same pixels to change in color, saturation or lightness.

At step 1150, based on the determined change in pixels as between the first and second images, the system may identify a first group of pixels that represent a first spray object. For example, the identified spray object may be any one of a spray impact on the agricultural object, a spray impact on a ground area about the agricultural object, or a spray projectile of the emitted first fluid projectile. The identified spray impact would indicate that a portion of the emitted spray contacted the agricultural object. The identified spray impact on the ground area would indicate that a portion of the emitted spray contacted an area about or adjacent to the agricultural object. The identified spray projectile would identify a line, shape, distance, or other geometry of the emitted fluid projectile.

At step 1160, the system may further optionally perform a line fitment process on the group of pixels to determine a line extending through the group of pixels. Line fitment processing is further described herein with respect to various embodiment of the agricultural treatment system.

In some embodiments, the system may further determine a quantity of fluid that impacted the ground area and/or that impacted the agricultural object. The system may identify the pixels that comprise the agricultural object, and the pixels depicting the spray impact on the ground and the spray impact on the agricultural object. If a large area or size of the spray impact on the ground is determined (such as a pixel area that is greater than a predetermined amount), the system may identify that due to the large area or size of the spray impact on the ground, that the emitted fluid likely did not properly impact the agricultural object. The system may record or index that the agricultural object was not properly treated. Also, the system may determine a centroid of the spray area on the ground, compute an offset from the centroid of the spray area on the ground, and then translate the offset to move the spraying head to account for being off target, and then emit another fluid projectile. The system may perform the above process again to evaluate whether the agricultural object was properly treated.

FIG. 11B illustrates an example implementation of method 1170 that may be performed by some embodiments of the system described above, including system 100, agricultural treatment system 400, system 600, and system 800. At step 1172, the system then emits a fluid projectile of a fluid from a spraying head. For example, the system may position a spraying head and then may emit a fluid projectile from the spraying head. At step 1174, using one or more images sensors, the system obtains a plurality of images depicting at least a portion of the emitted fluid projectile.

At step 1176, the system determines a group of pixels that represent the emitted fluid projectile. Object detection, image segmentation and/or image differencing processing may be applied to the plurality of the images identify or generate the group of pixels depicting the emitted fluid projectile. These techniques are further described herein.

At step 1178, the system may further perform a line fitment process on the group of pixels to determine a line extending through the group of pixels. Line fitment processing is further described herein with respect to various embodiment of the agricultural treatment system.

FIG. 11C illustrates example implementations of method 1180 that may be performed by some embodiments of the system described above, including system 100, agricultural treatment system 400, system 600, and system 800. At step 1182, the system obtains a first set of images depicting a background area. The system obtains with one or more image sensors at a first time period a first set of images. The first image includes multiple pixels depicting an area of a target location. The first image may be obtained prior to the emitting of a fluid projectile. At step 1184, the system then emits a fluid projectile of a fluid at a target location. For example, the system may position a spraying head and then may emit a fluid projectile from the spraying head at a target location (such as a target agricultural object, a location on the ground or at some other location). At step 1186, the system obtains a second set of images depicting at least a portion of the area. The system obtains with the image sensor at a second time period after the first time period, a second image including a plurality of pixels depicting the background area of the target location. The second image includes at least a portion of the same area as depicted in the first image.

At step 1188, the system determines a change in the second set of images as compared to the first set of images. For example, the system may compare the first image with the second image to determine a change in pixels between the first image and the second image. The first and second images may be compared to one another using various imaging comparison techniques to extract or identifying pixels in the second image that are different in pixel values (e.g., color values of 0-255). The system may perform a pixel alignment process to align common pixels or patterns or areas of the first and second images. The comparison of the images is meant to identify changes in the second image to indicate a spray impact on a ground area, a spray impact on the agricultural object and/or a spray splat.

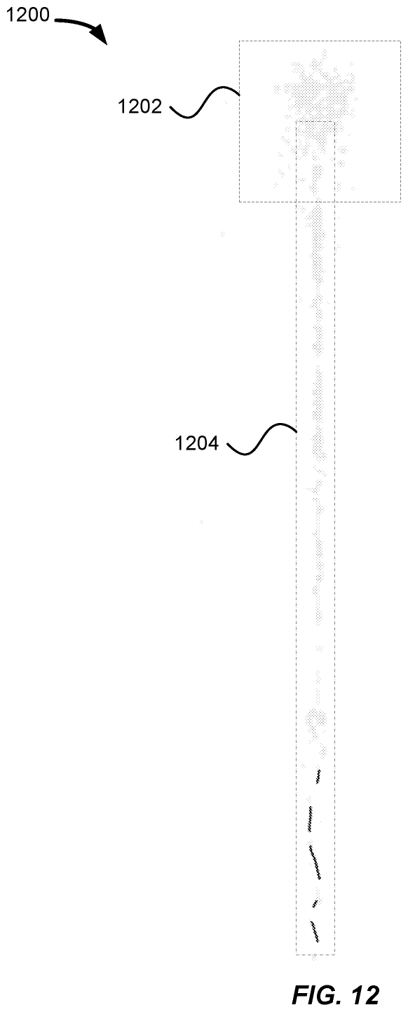

FIG. 12 is a diagram illustrating an exemplary image of a group pixels 1200 of an emitted fluid projectile and a spray impact. As described herein, the system may evaluate obtained images and identify groups of pixels that represent spray objects. In this example, the group of pixels 1200 represent a spray object of a spray projectile 1204 of and emitted first fluid projectile, and a spray object of a spray impact 1202. The group of pixels may be obtained from a series of images depicting the spray project from the time of emission from a spraying head to a time period shortly after an impact. The system may generate a video depicting pixel movement of the fluid projectile. The system may remove the pixels associated with spray projectile 1204 and store and catalogue the spray impact 1202. The spray impact 1202 may depict pixels which represent the resulting impact of the fluid projectile 1204, such as a spot of fluid, splat of fluid and/or splash of fluid.

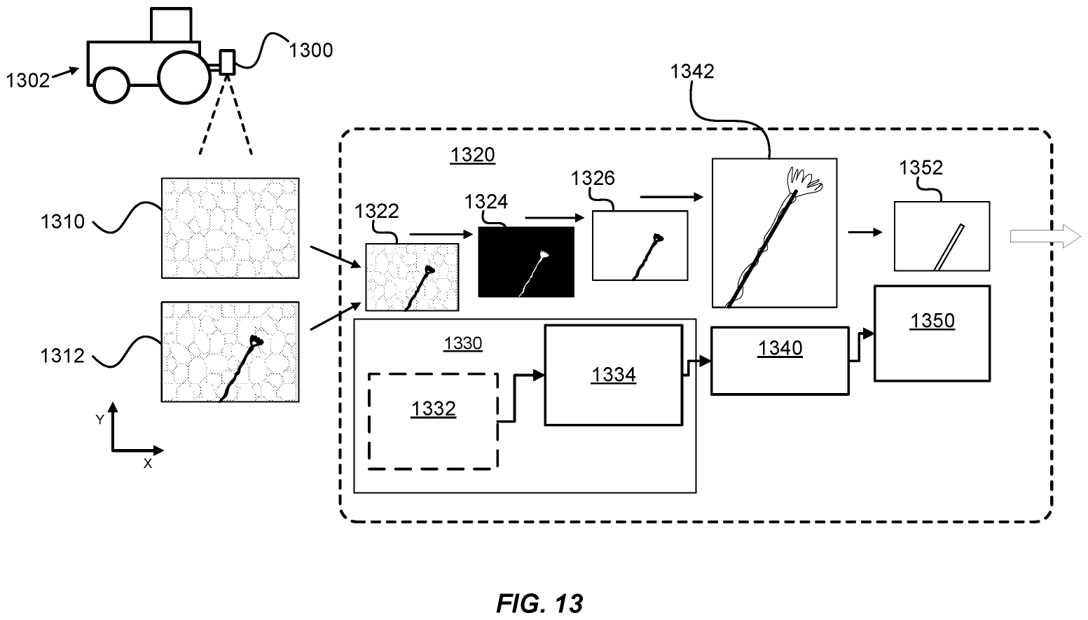

FIG. 13 is a diagram illustrating of an example the above method using a segmentation pipeline, where an agricultural treatment system may perform a spray evaluation process. In this example, an agricultural treatment system 1300 (e.g., attached to a vehicle 1302) may perform spray operations and obtain images (such as 3D images) of an emitted spray projectile. As described above, the system maneuvers a spraying head of a treatment unit and emits a fluid projectile. Prior to emitting the fluid projectile, the system obtains an image of a background area, target agricultural object or target location of where the system intends to spray or treat with the fluid. Image 1310 represents a first image obtained by the system at a first time period. Image 1312 represents a second image obtained by the system at a second time period after the first time period. The second image 1312 depicts at least a portion of the first image 1310 and depicts the emitted fluid projectile. Multiple images also may be captured of the emitted fluid projectile and then the images may be stitched together so as to depict the full path of the fluid projectile being emitted from a spraying head to the point of impact (e.g., on the ground, target agricultural object and/or a target location).

The system then processes the images to determine a line extending through a group of pixels representing the emitted fluid projectile. The obtained images may be processed through an image segmentation pipeline process 1320. The image segmentation pipeline 1320 extracts or identifies pixels in the images that depict the spray object (e.g., a spray impact on an agricultural object, a spray impact on a ground area about the agricultural object, a spray projectile of the emitted fluid projectile, or a combination thereof).

In one embodiment, the image segmentation pipeline process 1320, may use an image differencing process 1330 on images 1310 and 1312 (e.g., image segmentation masking 1334 as depicted by 1322 and 1324) to identify a group of pixels 1326 representing the spray object (e.g., 1200 of FIG. 12). The system may optionally perform a homography process 1332 of creating a homography matrix to account for image differencing in a moving vehicle. For example, as a vehicle is moving the agricultural treatment system, the point of view of an obtained image may slightly change from one to another. The system may correct or account for the point of view change in the obtained images when performing the image segmentation process 1320.

While not meant to be an exhaustive listing, other image comparison techniques that may be used to identify the group of pixels that represent the spray object include strict comparison, Hough transform, machine learning image processing, fuzzy pixel comparison, histogram comparison, correlation comparison, image masking, feature extraction, or any other pixel or object extraction known to one skilled in the art.

The group of pixels representing the spray object may then be processed via a line determination process to identify or calculate a line extending through the group of pixels 1326. Each of the pixels may have an associated 2D coordinate value (x, y) which represent the location/geometry of the pixels in a 2D space. A line fitting process 1340 may be used to determine a straight line extending through the pixels. Moreover, a curve fitting process may be used to determine a curved line extending through the pixels. One skilled in the art may use different known line or curve fitting techniques to determine a line extending through the group of pixels representing an emitted spray projectile. By way of illustration, but not limitation some of the techniques may include simple linear regression, orthogonal regression, deming regression, major axis regression, polynomial regression, and polynomial interpolation. The result of the line fitment process is a set of geometric data describing a determined curved or straight line that represents the fluid projectile. The geometric line data of the emitted spray projectile may be stored on a data store of the agricultural treatment system.

To further improve the accuracy of the line determination, the system may perform optional process of pixel erosions and/or pixel dilation 1350. Pixel erosion processing may remove pixels from the boundaries of the group of pixels. For example, this process would remove outlier pixels. Pixel dilation processing may add pixels to the group of pixels. Pixel erosion and pixel dilation processing may be performed prior to or after the line fitment process 1340.

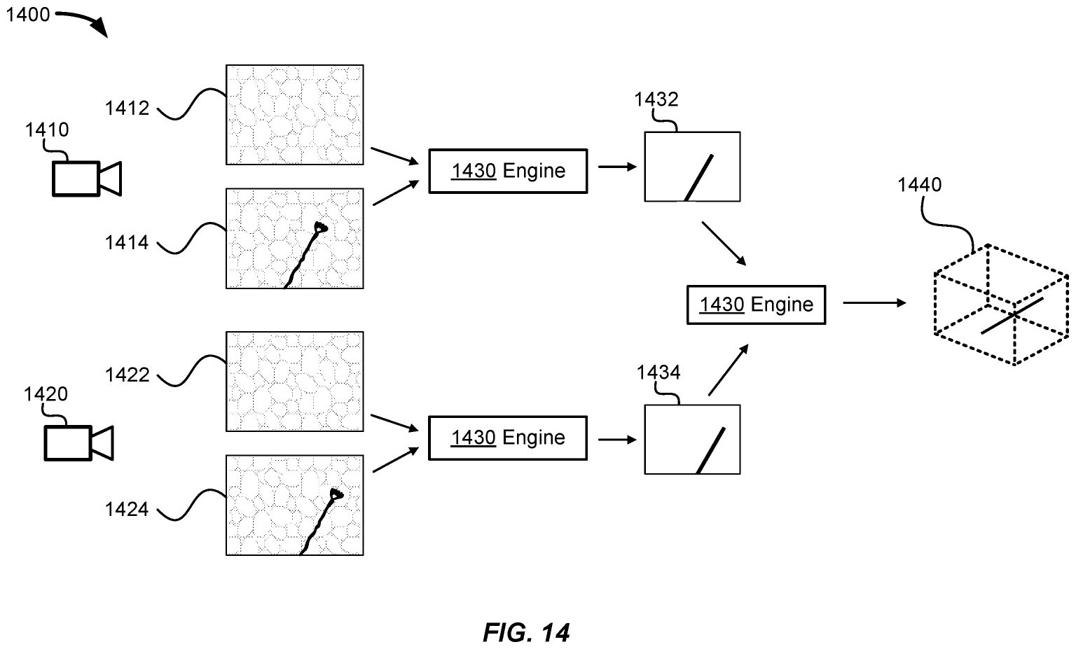

FIG. 14 is a diagram illustrating an exemplary method 1400 of spray object identification and line determination in a 3D space. In this example, a first image sensor 1410 and a second image sensor 1420 of a stereo pair of image sensors of the agricultural treatment system, each obtain a first image including pixels depicting a background and one or more second images including pixels depicting an emitted fluid projectile. The first image sensor 1410 and second image sensor 1420 may be positioned and oriented about the agricultural treatment system so that the field of view of each image sensor is overlapping. The two image sensors may be synchronized and triggered to each obtain an image at the same time. Each of the pixels may have an r value, g value, b value in an RGB color space, and optionally a d value indicating a distance from the focal plane of the image sensor.

At a first time period, the first image sensor 1410 obtains an image having pixels depicting a background 1412 from a first point of view (e.g., perspective) and the second image sensor 1420 obtains an image having pixels depicting a background 1422 from a second point of view. At least a portion of the pixels background of the image obtained by the first image sensor 1410 overlaps with a portion of the pixels of the background of the image obtained by the second image sensor 1420. The agricultural treatment system the emits a fluid projectile. The stereo pair of image sensors 1410, 1420 may obtain one or more images having pixels depicting the emitted fluid projectile. At a subsequent time period, the first image sensor 1410 obtains an image 1414 having pixels depicting the emitted fluid projectile, while the second image sensor 1420 obtains an image 1424 having pixels depicting the emitted fluid projectile.

The agricultural treatment system may use an image processing engine 1430 that evaluate images and determines a group of pixels that represent the emitted fluid projectile. Multiple images also may be captured of the emitted fluid projectile and then the images may optionally be stitched together by the image processing engine 1430 so as to depict the full path of the fluid projectile being emitted from a spraying head to the point of impact (e.g., on the ground, target agricultural object and/or a target location).

Image 1412 and image 1414 may be processed by image processing engine 1430, via one or more processors of the agricultural treatment system, and the engine may determine the geometry of a first line (such as a straight or curved line) extending through the group of pixels. Similarly, image 1422 and image 1424 may be processed by engine 1430, via one or more processors of the agricultural treatment system, and determine the geometry of a second line extending through the group of pixels.

The determination of the group of pixels and the determination of a line extending through the pixels may be performed by any of the methods as described herein, or any suitable image processing technique that would be evident to one skilled in the art based on the content of this application. The system may perform an iterative process to determine an optimal line extending through the group of pixels. For example, the system may conduct a project and reprojection to determine a reprojection error. The system determines the lines and cleaned up in each frame in stereo (1432, 1434). The system then fits a line in a 3-dimensional space by using projection/reprojection process. In other words, the system uses a prior determined line, and then iteratively, evaluates how much the 3-dimensional line fits back into the two 2d lines in each stereo image sensor, until the best line with the smallest reprojection error is found.

The image processing engine 1430 may then generate a 3D line object 1440 by compositing the geometries of the determined first line and the second line. The composited 3D line object would include a series of 3D points or locations that represent the line in a 3D space. The 3D line object may be stored in a data store and the later accessed by the agricultural treatment system. Each of the pixels of the 3D line object may have an associated 3D coordinate (x, y, z values) which represent the location/geometry of the pixels representing the line in a 3D space.

In one example, a method of evaluating a treatment of an agricultural object, includes obtaining with one or more image sensors at a first time period, a first set of images each comprising a plurality of pixels depicting a ground area and a first target agricultural object positioned in the ground area.

The method includes emitting a first fluid projectile of a first fluid at the first target agricultural object.

The method includes obtaining with the one or more image sensors at a second time period, a second set of images each comprising a plurality of pixels depicting the ground area and the agricultural object.

The method includes comparing the first image with the second image to determine a change in pixels between at least a first image of the first set of images and at least a second image of the second set of images.

The method includes based on the determined change in pixels as between the first and second images, identifying a first group of pixels that represent a first spray object.

The method further includes wherein the first group of pixels representing the first spray object comprises any one of a spray impact on the agricultural object, a spray impact on a ground area about the agricultural object, or a spray projectile of the emitted first fluid projectile.

The method further includes performing image segmentation to identify the first group of pixels that represent the first spray object.

The method further includes aligning the first image and the second image using features or common pixel patterns in the images generating a pixel mask of the first spray object.

The method further includes determining the first group of pixels of the first spray object is the spray impact on the agricultural object.

The method further includes determining a second group of pixels is second spray object of a spray impact on a ground area about the agricultural object.

The method further includes based on the group of pixels representing the spray impact on the agricultural object and the second group of pixels of the spray impact on the ground area, determining a quantity of the first fluid projectile that likely comprises the spray object.

The method further includes based on the group of pixels representing the spray object, determining a spray coverage percentage based on an average of the multiple fluid projectiles identified to have actually been sprayed upon their intended target object.

The method further includes based on the group of pixels representing the spray object, identifying a line of the spray object, wherein the spray object is the spray projectile of the emitted first fluid projectile.

The method further includes identifying pixels in the images depicting the first fluid projectile line fitting the identified pixels to determine the spray line of the spray projectile.

The method further includes performing a Hough line detection operation on the first group of pixels to identify the spray line of the spray projectile.

The method further includes determining a change in pixels (colors/luminosity/etc.) that are above a threshold value.

The method further includes wherein the second time period is temporally later than the first time period, and the duration between the first time period and second time period is less than 60 seconds.

The method further includes based on the first group of pixels representing the first spray object, determining a first emission pattern of the first fluid projectile and indexing the first spray object as the first emission pattern.

The method further includes based on the first group of pixels representing the first spray object, determining a first treatment pattern and indexing the first spray object as the first treatment pattern.

The method further includes based on the first group of pixels representing a first spray object, indexing the agricultural object as being treated.

The agricultural treatment system may perform various calibration operations to calibrate moveable components of the system. In some embodiments, the system may operate in a calibration mode where the treatment system performs spray operations and observes an impact and/or location of an emitted fluid projectile from a treatment of a treatment unit. The treatment system may record the position or value of a motor encoder coupled to a motor. As previously discussed, treatment unit processors are configured to determine and evaluate the positions of the motors via the encoders coupled to the motors. The treatment unit processer obtains information from the microcontroller of the treatment unit regarding the encoder's output. For example, the data or values obtained from the motor encoder may be a positional value such a negative or positive numeric value offset from a zero or base position, or a negative or positive voltage value to rotate a motor to a desired position. As described herein, the motors are actuated to move a spraying head to a desired position to emit a fluid projectile.

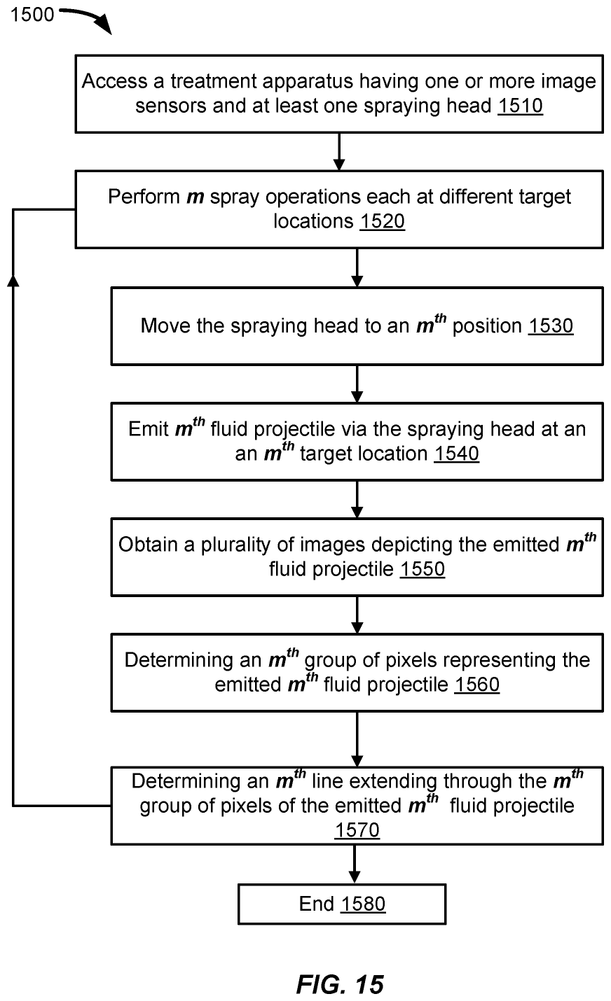

FIG. 15 illustrates example implementations of method 1500 that may be performed by some embodiments of the system described above, including system 100, agricultural treatment system 400, system 600, and system 800. At step 1510, a treatment apparatus is provided or accessed (such an agricultural treatment system, treatment unit or treatment apparatus as described herein). The treatment apparatus may have one or more image sensors configured to obtain 3-dimensional image data. The treatment apparatus includes at least one spraying head configured to emit a fluid projectile where the spraying head moveable about an Θ position and a Ψ position. The agricultural treatment system may perform a series of calibration operations where the system emits a fluid projectile and records the positional information of the spraying head (such as an Θ position and Ψ position). The agricultural treatment system may also record values from the micro encoder indicating a positional offset value or voltage value to rotate a motor to move the spraying head.

At step 1520, the system performs m operations each at different target locations. For each of the multiple operation, the system performs m^{th} operations, wherein m is an integer value greater than or equal to 2.

At step 1530, the system moves the spraying head to an m^{th} position. For example, the spraying head may be moved along to an m^{th} Θ position value and to an m^{th} Ψ position value. For example, the Θ position value and Ψ position value may be a rotational value to move the spraying head.) Also, motors controlling the spraying head may be rotated to adjust a position of the spraying head. The system may instruct a first and second motor to rotate to a desired positions which in turn, via linkages (as described above), move the spraying head to a desired position. After the spraying head is moved to a desired position, at step 1540, the system emits an m^{th} fluid projectile at an m^{th} target location. At this step, the spraying head emits a fluid projectile at a desired target location.

At step 1550, the system obtains, via the one or more image sensors, a plurality images of the m^{th} emitted fluid projectile (For example, the system may obtain 2-dimensional and/or 3-dimensional images). At this step, the system obtains imagery capturing or showing the fluid projectile that is emitted from the spraying head. Multiple sequential images may be obtained to capture the fluid projectile at different time intervals.

At step 1560, the system may determine an m^{th} group of pixels representing the emitted m^{th} fluid projectile. At this step, the system may process the images using any of the techniques described herein to identity a group of pixels that represent the emitted m^{th} fluid projectile.

At step 1570, the system may determine an m^{th} line extending through the Θ position determined m^{th} group of pixels. At this step, the system may process the m^{th} group of pixels to determine a line extending through group of pixels. For example, the system may use any of the techniques (e.g., line fitting) described herein to identify a line extending through the group of pixels. In one embodiment, the line may be a 3-dimensional line object. The system may generate a look up or cross reference table or other data structure or type where the line geometry is associated with the position value associated Θ position with the position of the spraying head. The operations may end at step 1580.

In one embodiment, the following Table 1 illustrates an example lookup table that may be created for a number of emitted sprays at different target locations. For example, Table 1 may include Motor1 and Motor2 offset values for use in positioning a spraying head to a desired position to emit a fluid projectile that would impact a real-world location at an x, y, z coordinate. Based on an x, y, z coordinate of a target location, the system may use the 3D line coordinates to determine where to position the spraying head. For example, the system evaluates whether the x, y, z coordinate is a matching coordinate to any point to any one of the 3D line segments. If there is a match, then the system uses the corresponding Motor1 and Motor2 offset values to move a spraying head to a desired position to emit the fluid projectile. Where the system, does not find an exact match of the x, y, z location as a point on a 3D line segment, then the system may interpolate among multiple 3D line segments and derive interpolated Motor1 and Motor2 offset values. The system would then use the interpolated Motor1 and Motor 2 Offset values to move the spraying head the desired position to emit the fluid projectile. As an example, the Motor1 and Motor2 Offset values may be a voltage and time duration, a positive or negative rotational value. The Motor1 and Motor2 Offset values would be used by the system to rotate a first and second motor which moves the spraying head to a desired position.

TABLE 1
Motor Offset Calibration Table

| 3D Line Segment | Motor1 Position | Motor2 Position |
|---|---|---|
| 3D line coordinates | Motor1 Offset value | Motor2 Offset value |
| 3D line coordinates | Motor1 Offset value | Motor2 Offset value |
| 3D line coordinates | Motor1 Offset value | Motor2 Offset value |
| 3D line coordinates | Motor1 Offset value | Motor2 Offset value |

In one embodiment, the following Table 2 illustrates an example lookup table that may be created for a number of emitted sprays at different target locations. For example, Table 2 may include spraying head Θ position and Ψ position values for use in positioning a spraying head to a desired position to emit a fluid projectile that would impact a real-world location at an x, y, z coordinate. Based on an x, y, z coordinate of a target location, the system may use the 3D line coordinates to determine where to position the spraying head. For example, the system evaluates whether the x, y, z coordinate is a matching coordinate to any point to any one of the 3D line segments. If there is a match, then the system uses the corresponding Θ position and Ψ position values to move a spraying head to a desired position to emit the fluid projectile. Where the system, does not find an exact match of the x, y, z location as a point on a 3D line segment, then the system may interpolate among multiple 3D line segments and derive interpolated Θ position and Ψ position values. The system would then use the interpolated Θ position and Ψ position values to move the spraying head the desired position to emit the fluid projectile.

TABLE 2
Spraying Head Offset Calibration Table

| | Spraying head | Spraying |
|---|---|---|
| | theta position | head psi |
| 3D Line Segment | value | position value |
| 3D line coordinates | Θ position value | Ψ position value |
| 3D line coordinates | Θ position value | Ψ position value |
| 3D line coordinates | Θ position value | Ψ position value |
| 3D line coordinates | Θ position value | Ψ position value |

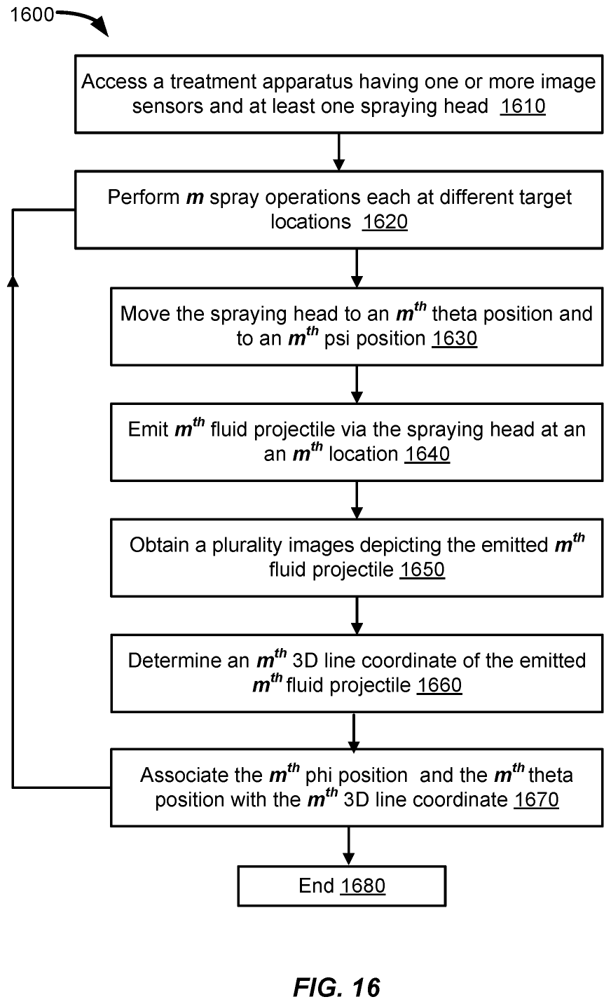

FIG. 16 illustrates example implementations of method 1600 that may be performed by some embodiments of the system described above, including system 100, agricultural treatment system 400, system 600, and system 800. At step 1610, a treatment apparatus is provided or accessed (such an agricultural treatment system, treatment unit or treatment apparatus as described herein). The treatment apparatus may have one or more image sensors configured to obtain 2-dimensional and/or 3-dimensional image data. The treatment apparatus includes at least one spraying head configured to emit a fluid projectile where the spraying head moveable about an Θ position/direction and a Ψ position/direction. The agricultural treatment system may perform a series of calibration operations where the system emits a fluid projectile and records the positional information of the spraying head (such as an Θ position and Ψ direction). The agricultural treatment system may also record values from the micro encoder indicating a positional offset value or voltage value to rotate a motor to move the spraying head.

At step 1620, the system performs m operations each at different target locations. For each of the multiple operation, the system performs mth operations, wherein m is an integer value greater than or equal to 2. At step 1630, the system moves the spraying head to an mth Θ position value and to an mth Ψ direction. The system may instruct a first motor and second motor to rotate to a desired positions which in turn, via linkages (as described above), move the spraying head to a desired spraying position. After the spraying head is moved to a desired spraying position, at step 1640, the system emits an mth fluid projectile at an mth location. At this step, the spraying head emits a fluid projectile at a location in environment of the agricultural treatment system. At step 1650, the system obtains, via the one more image sensors, a plurality of images of the mth location. At this step, the system obtain imagery capturing or showing the fluid projectile that is emitted from the spraying head. Multiple sequential images may be obtained to capture the fluid projectile at different time intervals. At step 1660, based on the received plurality of 3-dimensional images of the mth target, the system may determine an mth 3D line coordinate of the emitted mth fluid projectile. Using the obtained images, the system may determine 3D line coordinates representing the mth fluid projectile and optionally impact location (such as x-, y-, z-coordinate location) of where the mth fluid projectile impacted. At step 1670, the system may associate the mth Θ position value and the mth direction with the 3D line coordinates representing the mth fluid projectile and/or the mth x, y, z location value. The determination of 3D line coordinates is further described herein, and more generally referred to as line fitment.

In one embodiment, the system may generate a look up or cross reference table or other data structure or type where the 3D line coordinates representing the mth fluid projectile is associated with a motor offset value for a first motor, and a motor offset value for a second motor. In another embodiment, the system may generate a look up or cross reference table or other data structure or type where the 3D line coordinates representing the mth fluid projectile is associated with the Θ position and Ψ direction of the spraying head.

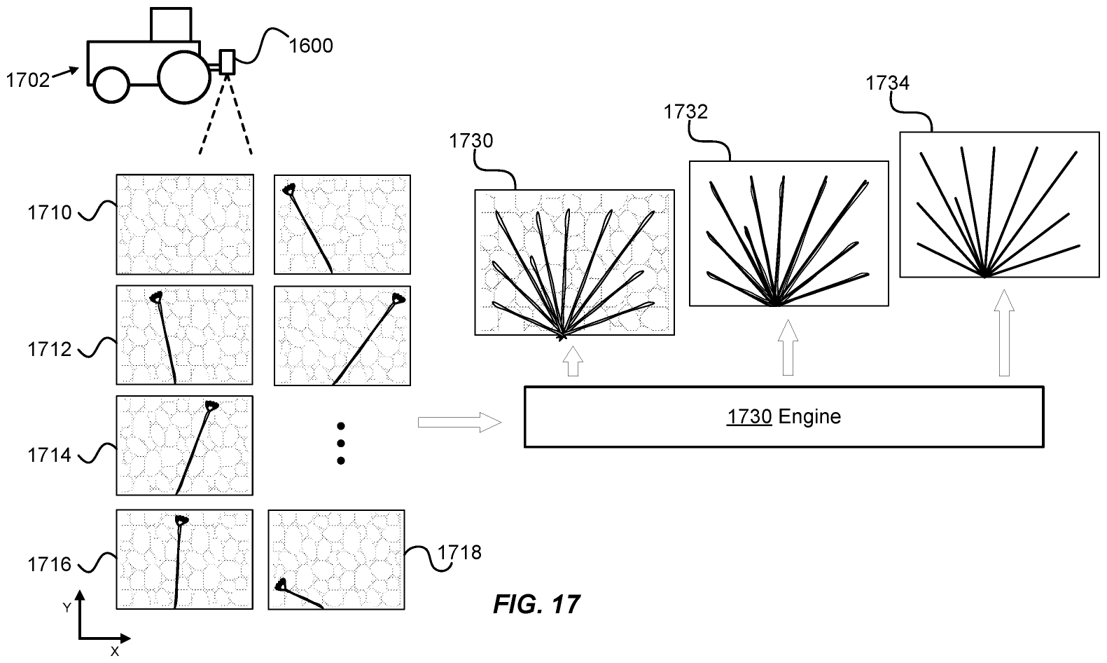

FIG. 17 is a diagram illustrating an example of methods described herein, where an agricultural treatment system may perform a calibration process. In this example, an agricultural treatment system 1702 using a treatment unit 1700 may perform repeated m number of spray operations (e.g., 1710 through 1718) and obtain images (such as 3D images) of an emitted spray projectile. As described above, the system maneuvers a spraying head of a treatment unit to various positions and emits a fluid projectile. The system may perform this operation m number of times. Images of the emitted fluid projectiles are obtained by the system. The system records the positional information of the motors and/or the position information of the spraying head.

In some embodiments, the agricultural treatment system may have multiple treatment units (see FIG. x). For example, there may be four treatment units attached to pulled trailer. The calibration process described above may be performed with respect to each of the treatment units. For each spraying head of a treatment unit, the calibration process may be performed concurrently for each treatment unit, or separately in series for each treatment unit. Where the agricultural treatment system calibrates multiple treatment units, the agricultural system would create a calibration or lookup table for the respective treatment unit. A single table or data source may be used, where the data source includes a unique identifier (UUID) for each treatment unit. The UUID is associated with each of the 3D location values and the Motor Position/Spraying head Position values.

An image evaluation engine 1730 may be provided or accessed which is configured to identify a group of pixels that represent an emitted spray projectile from obtained imagery depicting an actual emitted spray projectile. The group of pixels may then be processed via a line determination process to identify or calculate a line extending through the group of pixels. For example, the captured images may be further processed via an image evaluation engine 1730. The image evaluation engine 1730 may identify, from the obtained images, pixels representing a particular spray object depicting an emitted spray projectile. As described previously, various pixel extraction techniques may be used to identify pixels representing a spray object. The image evaluation engine 1730 may then process the group of pixels that represent a particular emitted spray projectile to determine a line of the extending through the group of pixels. Each of the pixels may have an associated 3D coordinate (x, y, z). A line fitting process may be used to determine a straight line extending through the pixels. Moreover, a curve fitting process may be used to determine a curved line extending through the pixels. One skilled in the art may use different known line or curve fitting techniques to determine a line extending through the group of pixels representing an emitted spray projectile. By way of illustration, but not limitation some of the techniques may include simple linear regression, orthogonal regression, deming regression, major axis regression, polynomial regression, and polynomial interpolation.

A composite group of emitted spray projectiles depicted in the images are represented as 1730. The group of spray objects depicting an emitted spray projectile are represented as 1732. The group of determined lines for the respective spray objects is depicted as 1734.

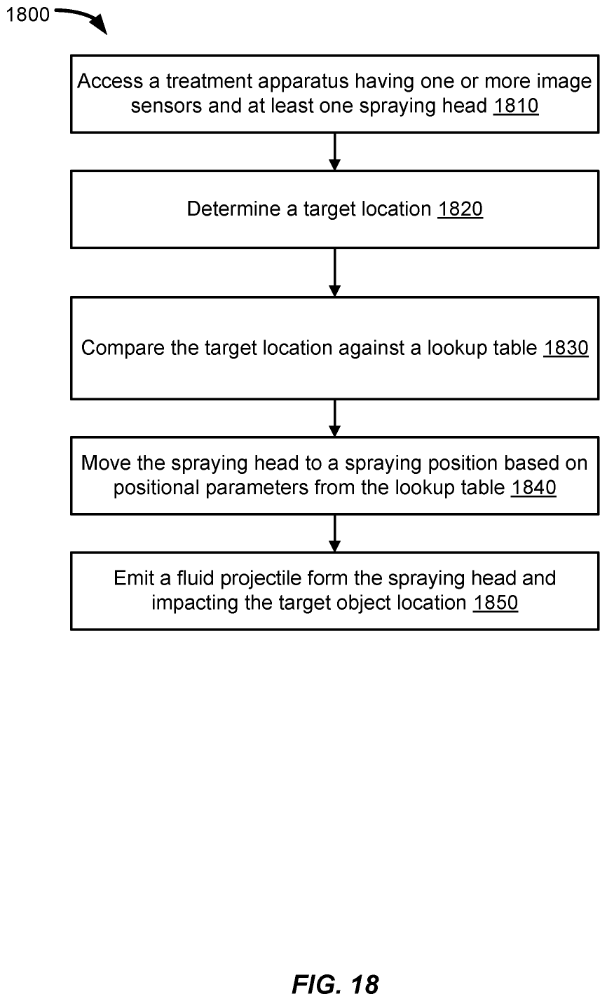

FIG. 18 illustrates example implementations of method 1800 that may be performed by some embodiments of the system described above, including system 100, agricultural treatment system 400, system 600, and system 800. In one embodiment, the agricultural treatment system may perform spray operations using calibrated components of the system. In some embodiments, the system may perform treatment operation using a calibration or lookup table. The agricultural treatment system determines a target location, such as a target agricultural object, and then positions a spraying head using the calibration or lookup table (such as Table 1 or Table 2 described above).

At step 1810, a treatment apparatus a treatment apparatus is provided or accessed (such an agricultural treatment system or treatment apparatus described herein). The treatment apparatus may have one or more image sensors configured to obtain image data (such as 2-dimensional or 3-dimensional image data). The treatment apparatus includes at least one spraying head configured to emit a fluid projectile where the spraying head moveable about an Θ position and a Ψ position. The system may include a non-transitory data storage comprising a data source having multiple associated values pairs of an Θ position and a Ψ position values with 3D line coordinate values.

At step 1820, the system determines a target location. The system determines an intended target location (such as location of a first target agricultural object for treatment), wherein the target location comprises a first x, y, z coordinate value. For example, the first x, y, z value may be a coordinate value in 3-dimensional space of an environment about the agricultural treatment system.

At step 1830, the system compares the x, y, z value against the look up table (e.g., Table 1 or Table 2). Where the system finds a match of the x, y, z value to a point along one of the 3-dimensional lines in the look up table, the system uses the associated positional values in the data source to move the spraying head. Where the system does not find an exact match of the x, y, z location, the system may interpolate between two 3-dimensional lines from the data source, and derive an interpolated positional values to move the spraying head to a spraying position. At step 1850, the system then emits a first fluid projectile from the spraying head and impacts the first target object with the emitted first fluid projectile.

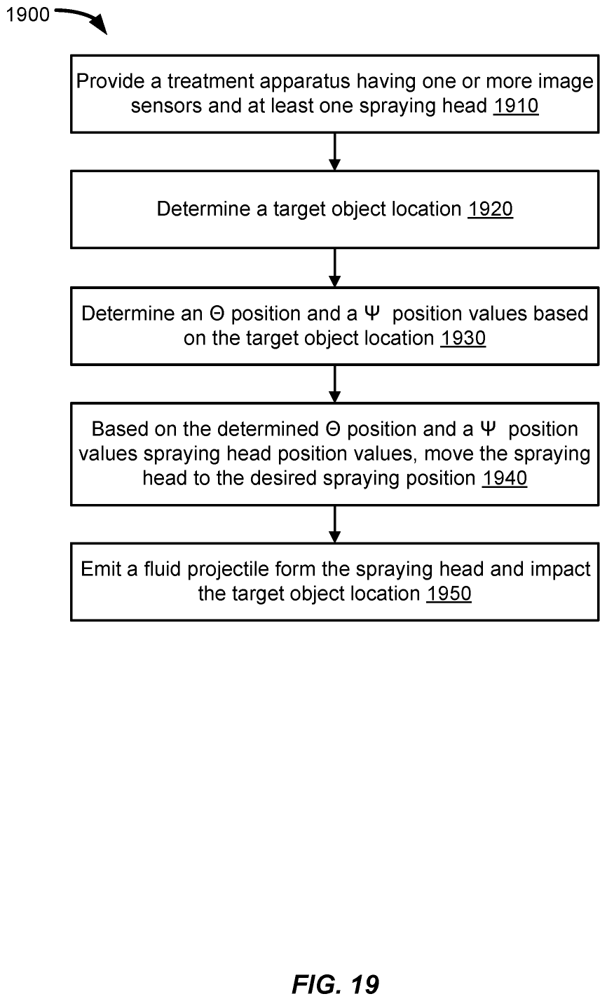

FIG. 19 illustrates example implementations of method 1900 that may be performed by some embodiments of the system described above, including system 100, agricultural treatment system 400, system 600, and system 800. In another embodiment, the agricultural treatment system may perform spray operations using calibrate components of the system. In some embodiments, the system may perform treatment operation using a calibration or lookup table. The agricultural treatment system determines a target location, such as a target agricultural object, and then positions a spraying head using the calibration or lookup table.

At step 1910, a treatment apparatus a treatment apparatus is provided or accessed (such an agricultural treatment system or treatment apparatus described herein). The treatment apparatus may have one or more image sensors configured to obtain 3-dimensional image data. The treatment apparatus includes at least one spraying head configured to emit a fluid projectile where the spraying head moveable about an Θ position and a Ψ 0 position. The system may include a non-transitory data storage comprising a data source having multiple associated values pairs of an Θ position and a Ψ position with an x, y, z value.

At step 1920, the system determines a target object location. The system determines a target location of a first target agricultural object for treatment, wherein the target location of the first target object comprises a first x, y, z value. For example, the first x, y, z value may be a coordinate value in 3-dimensional space of an environment about the agricultural treatment system.

At step 1930, the system determines an Θ position and a Ψ position spraying head position values based on the target object location. Using the data source, the system compares the intended target location coordinates to one or more x, y, z values, and then determines a first Θ position value and a first Ψ position value. For example, the system may first search or try to match x, y, z values of the target location with an x, y, z value of the data source to find a matching location. If the x, y, z value is found, then the system may use a matched Θ position value and Ψ position value from the data source as the first Θ position value and the first Ψ position value. Where the system does not find a match of an x, y, z value, the system may then interpolate or approximate for an interpolated first Θ position value and a first Ψ position value. The system may interpolate between two or more x, y, z values, and then calculate an interpolated Θ position value and an interpolated Ψ position value.

At step 1940, based on the determined Θ position and Ψ position spraying head position values, move the spraying head to the Θ position and Ψ position. Either then based on a matched Θ position value and y-value, or the interpolated Θ position value and Ψ position value the system move the spraying head to the determined Θ position value and to Ψ position value. At step 1950, the system then emitting a first fluid projectile from the spraying head and impacting the first target object with the emitted first fluid projectile.

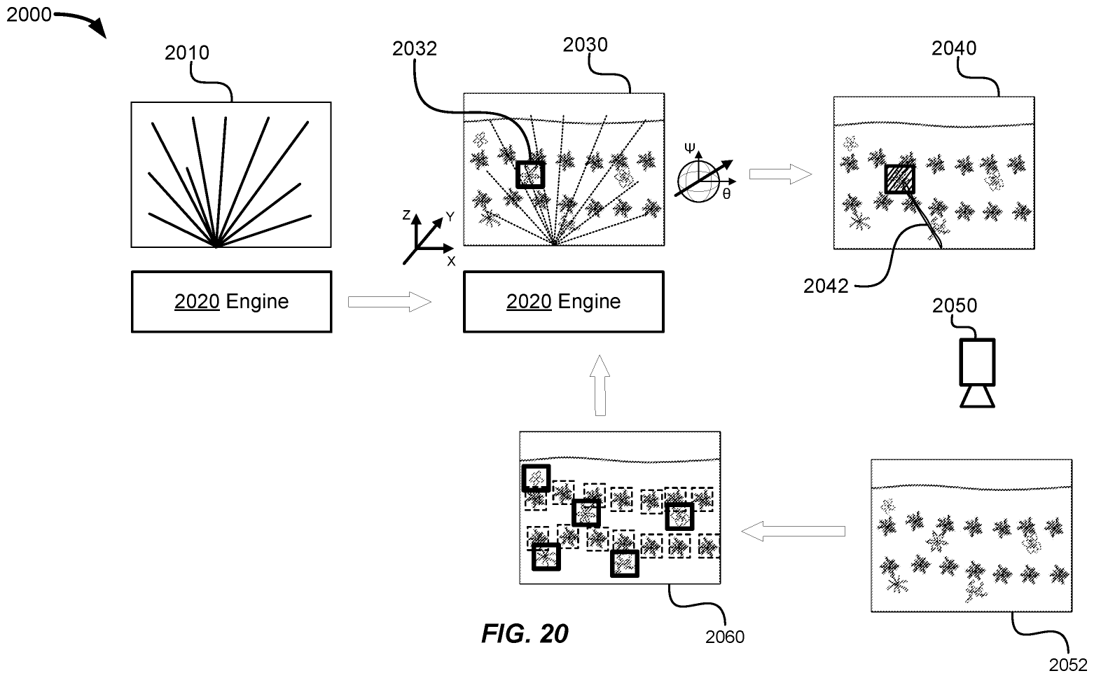

FIG. 20 is a diagram illustrating an example using a calibrated agricultural treatment system. In this example, the determined lines from the calibration are depicted as element 2010. An engine 2020, operable by one or more processors of the agricultural treatment system, may be used to determine an adjustment to a spraying head of a treatment unit. As discussed previously, a calibration profile using a look up or other type of calibration table may be accessed by the engine 2020 to identify an x-y position of a spraying head. Element 2030 depicts an obtained image with a logical placement or a map indicating those locations of calibrated lines (e.g., element 2010) to corresponding target locations in a 3D space. A number of real-world agricultural objects are depicted in the image (e.g., 2032). An overlay of the map is shown to illustrate where an emitted fluid projectile would impact in reference to agricultural objects depicted in the image 2030 according to a particular calibration line.

As described previously, the system identifies a target location, and then emits a fluid at the target location. The spraying head of a treatment unit is moved to a particular position based on the intended location of the target. Where an intended location does not correspond to a location of one of the calibration lines, the system may interpolate among two or more calibrations lines to determine an associated position to move the spraying head such that the spraying head would impact the intended location with an emitted fluid projectile.

The emitted fluid projectile is represented by element 2040 showing the fluid projectile impacting an area, such as the ground or a target agricultural object. A image sensor 2050 of the agricultural system may obtain one or more images 2052 of where the fluid projectile impacted.

As depicted in element 2060, the system may catalogue and index the location of the impact of the emitted fluid projectile. Each of the depicted agricultural objects may have a unique identifier and a line of the emitted spray may be associated with the unique identifier. The system then may confirm or validate which of the target agricultural objects (e.g., object 2032) were actually sprayed or impacted by the emitted fluid projectile. For example, the engine 2020 may identify the pixels that comprise the target agricultural object, and the pixels depicting the spray impact on the ground and the spray impact on the agricultural object. If a large area or size of the spray impact on the ground is determined (such as a pixel area that is greater than a predetermined amount), the engine 2020 may identify that due to the large area or size of the spray impact on the ground, that the emitted fluid likely did not properly impact the agricultural object. The system may record or index that the agricultural object was not properly treated. Also, the system may determine a centroid of the spray area on the ground, compute an offset from the centroid of the spray area on the ground, and then translate the offset to move the spraying head to account for being off target, and then emit another fluid projectile. The system may perform the above process again to evaluate whether the agricultural object was properly treated.

While the disclosure has been particularly shown and described with reference to specific examples thereof, it should be understood that changes in the form and details of the disclosed examples may be made without departing from the scope of the disclosure. Although various advantages, aspects, and objects of the present disclosure have been discussed herein with reference to various examples, it will be understood that the scope of the disclosure should not be limited by reference to such advantages, aspects, and objects. Rather, the scope of the disclosure should be determined with reference to the claims.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk, optical disks, CD-ROMs, and magnetic-optical disks, read-only memories (ROMs), random access memories (RAMs), EPROMs, EEPROMs, magnetic or optical cards, solid state drives, flash drives, SATA drives, NAND and 3D NAND flash drives, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method of calibrating a treatment apparatus, the method comprising:
accessing a treatment apparatus, the treatment apparatus comprising:
one or more image sensors configured to obtain image data; and
at least one spraying head configured to emit a fluid projectile, the spraying head moveable about an Θ position and a Ψ position;
performing m^{th} operations, wherein m is an integer value greater than or equal to 2, of:
moving the spraying head to an m^{th} Θ position;
emitting an m^{th} fluid projectile at an m^{th} target location;
obtaining, via the image sensors, a plurality of images of the emitted m^{th} fluid projectile;
determining an m^{th} group of pixels representing the emitted m^{th} fluid projectile; and
determining an m^{th} line extending through the m^{th} group of pixels of the emitted m^{th} fluid projectile.

2. The method of claim 1, further comprising:
based on the received plurality images, determining an m^{th} location value of an impact location of the emitted m^{th} fluid projectile; and
associating the m^{th} position of the spraying head to an Θ position the m^{th} location value of the target m^{th} location.

3. The method of claim 1, further comprising:
generating a lookup table wherein the lookup table comprises:
each of an m^{th} Θ position value and an m^{th} Ψ position value are associated with an m^{th} x, y, z location value of the target location.

4. The method of claim 3, further comprising:
determining a target location of a first target agricultural object for treatment, wherein the target location of the first target object comprises a first x, y, z location value;
comparing the first x, y, z location value to the lookup table, and determining a first Θ position value and a first Ψ position value;
moving the spraying head to the first Θ position value and to first Ψ position value; and
emitting a first fluid projectile from the spraying head and impacting the first target object with the emitted first fluid projectile.

5. The method of claim 3, further comprising:
interpolating between two or more x, y, z location values, and calculating an interpolated Θ position value and an interpolated Ψ position value, wherein the first Θ position value is the interpolated Θ position value and the first Ψ position value is the interpolated Ψ position value.

5. The method of claim 3, further comprising:
obtaining one or more additional images, the one or more additional images each comprising pixels depicting the target object and pixels depicting the first fluid projectile.

6. The method of claim 5, further comprising:
evaluating the one or more additional images to determine a spray line of the fluid projectile.

7. The method of claim 6, wherein evaluating the one or more additional images to determine a spray line comprises:
identifying pixels in the images depicting the first fluid projectile; and
line fitting the identified pixels to determine the spray line of the fluid projectile.

8. A method of treating an agricultural object with a calibrated treatment apparatus, the method comprising:
accessing a treatment apparatus, the treatment apparatus comprising:
one or more image sensors configured to obtain 3-dimensional image data; and
at least one spraying head configured to emit a fluid projectile, the spraying head moveable about an Θ position and a Ψ position; and
a non-transitory data storage comprising a data source having multiple associated values pairs of an Θ position and a Ψ position with an x, y, z value;
determining a target location of a first target agricultural object for treatment, wherein the target location of the first target object comprises a first x, y, z value;
comparing, using the data source, the target location to one or more x, y, z values, and determining a first Θ position value and a first Ψ position value;
moving the spraying head to the determined first Θ position value and to first Ψ position value; and
emitting a first fluid projectile from the spraying head and impacting the first target object with the emitted first fluid projectile.

9. The method of claim 8, further comprising:
interpolating between two or more x, y, z values, and calculating an interpolated Θ position value and an interpolated Ψ position value, wherein the first Θ position value is the interpolated Θ position value and the first Ψ position value is the interpolated Ψ position value.

10. The method of claim 9, further comprising:
obtaining one or more additional images, the one or more additional images each comprising pixels depicting the target object and pixels depicting the first fluid projectile.

11. The method of claim 10, further comprising:
evaluating the one or more additional images to determine a spray line of the fluid projectile.

12. A system for treating agricultural objects, the system comprising:
a first treatment unit, first treatment unit having at least one spraying head configured to emit a fluid projectile, the spraying head moveable about an Θ position and a Ψ position;
one or more image sensors configured to obtain 3-dimensional image data; and
one or more processors, the one more processors configured to:
perform m^{th} operations, wherein m is an integer value greater than or equal to 2, of:
instruct the spraying head to an m^{th} Θ position value and to an m^{th} Ψ position value;
cause the emitting an m^{th} fluid projectile at an m^{th} target;
obtain, via the two image sensors, a plurality of 3-dimensional images of the m^{th} target;
based on the received plurality of 3-dimensional images of the m^{th} target, determine an m^{th} x, y, z location value of an impact location of the emitted m^{th} fluid projectile; and
associate the m^{th} Θ position value and the m^{th} Ψ position value with the x, y, z location value.

13. The system of claim 12, wherein the one more processors are further configured to:
generate a lookup table wherein the lookup table comprises:
each of the m^{th} Θ position value and the m^{th} Ψ position value are associated with the m^{th} x, y, z location value.

14. The system of claim 12, wherein the one more processors are further configured to:
determine target location of a first target agricultural object for treatment, wherein the target location of the first target object comprises a first x, y, z location value;
compare the first x, y, z location value to the lookup table, and determine a first Θ position value and a first Ψ position value;
instruct, via a controller, the spraying head to the first Θ position value and to first Ψ position value; and
cause the emitting of a first fluid projectile from the spraying head and impacting the first target object with the emitted first fluid projectile.

15. The system of claim 14, wherein the one more processors are further configured to:
interpolate between two or more x, y, z location values, and calculate an interpolated Θ position value and an interpolated Ψ position value, wherein the first Θ position value is the interpolated Θ position value and the first Ψ position value is the interpolated Ψ position value.

16. The system of claim 14, wherein the one more processors are further configured to:
obtain one or more additional images, the one or more additional images each comprising pixels depicting the target object and pixels depicting the first fluid projectile.

17. The system of claim 16, wherein the one more processors are further configured to:
evaluating the one or more additional images to determine a spray line of the first fluid projectile.

18. The system of claim 17, wherein evaluating the one or more additional images to determine a spray line comprises:
identifying pixels in the images depicting the first fluid projectile; and
line fitting the identified pixels to determine the spray line of the fluid projectile.

21. A method of treating an agricultural object with a calibrated treatment apparatus, the method comprising:
providing a treatment apparatus, the treatment apparatus comprising:
one or more image sensors configured to image data; and
at least one spraying head configured to emit a fluid projectile, the spraying head moveable about an Θ position and a Ψ position; and
a non-transitory data storage comprising a data source having multiple associated values pairs of a 3-dimensional location values and three-dimensional line geometries;
determining a target location of a first target agricultural object for treatment, wherein the target location of the first target object comprises a first x, y, z value;
determining a three-dimensional line geometry based on the target location;
moving the spraying head based a three-dimensional line geometry; and
emitting a first fluid projectile from the spraying head and impacting the first target object with the emitted first fluid projectile.

22. The method of claim 21, wherein determining the three-dimensional line geometry comprises:
comparing, using the data source, the target location to the 3-dimensional location values.

23. The method of claim 22, further comprising:
interpolating between two or more target location values from the data source, and calculating an interpolated a three-dimensional line geometry.
